(19) United States
(12) Patent Application Publication
(10) Pub. No.: US 2017/0249428 A1
(43) Pub. Date: Aug. 31, 2017

(54) System and Method for Facilitating Treatment of a Patient

(71) Applicant: THE REGENTS OF THE UNIVERSITY OF MICHIGAN, Ann Arbor, MI (US)

(72) Inventors: Charles Mayo, Saline, MI (US); Dale Litzenberg, Pinckney, MI (US)

(21) Appl. No.: 15/445,967

(22) Filed: Feb. 28, 2017

Related U.S. Application Data
(60) Provisional application No. 62/301,082, filed on Feb. 29, 2016.

(51) Int. Cl. G06F 19/00

(52) U.S. Cl. CPC G06F 19/345; G06F 19/325; G06F 19/321

(57) ABSTRACT

A system and method for generating a display to improve decision making of treatment options for a patient by utilizing an evaluation metric and treatment-plan experience of other patients with characteristics similar to the patient, thereby assisting a physician in choosing a patient-treatment plan for the individual patient.

### CROSS REFERENCE TO RELATED APPLICATIONS

The present application claims the benefit of U.S. Provisional Application No. 62/301,082, filed on Feb. 29, 2016; the content of which is hereby incorporated by reference herein in its entirety.

### TECHNICAL FIELD

This application is generally related to facilitating treatment of a patient, and, more specifically, to a system, method, and computer-readable medium for evaluating a patient treatment-plan based on the historical experience of the patient treatment-plan. In particular, the method generates a display to improve decision making for treatment options of a patient with a medical condition by providing a visual quantitative comparison of the patient's treatment data with historical experience patient treatment data.

### BACKGROUND

Traditional methods of evaluating patient treatment-plans do not include quantitative evaluation of the patient treatment-plan with respect to past experience and/or historical data of the patient treatment-plan with other patients. Further, clinical decision making at the point of care is not strongly supported by evidence from direct comparison with historical experience as it evolves. For example, prescriptions and written directives used to develop patient treatment-plans that implement radiation therapy typically specify a discrete dose volume histogram (DVH) objective(s) and qualitative values for prioritization. How a given plan compares to previous experience is usually a qualitative evaluation, e.g., “the value seems high.” This objective(s) may be defined or evaluated according to historical experience with an incidence of toxicity (normal tissue complication probability (NTCP)) or tumor control (tumor control probability (TCP)) associated with a threshold(s) for a DVH metric value(s). Radiobiological metrics models such as NTCP and TCP provide an overall score reflecting a model of tissue response; however, empirical experience with recognition of critical dose thresholds evolves more quickly than an understanding of mechanisms of radiation response. Unfortunately, this objective(s) and prioritized qualitative value(s) are evaluated individually without an overall score to reflect an ability to meet the objective(s). Moreover, these approaches do not enable automatically incorporating historical experience as it evolves.

Additionally, quantifying practice experience in meeting DVH constraints for groups of patients to characterize differences over time, between clinics, or among technologies, is difficult to summarize with only a few measures. Developing analytics in the form of metrics, visualization methods, and software applications that use historically grouped data to: 1) quantify overall practice experience, and 2) score individual treatment plans could improve these comparisons. Analytics developed to quantify and/or visualize DVH curves and metrics for a given treatment-plan compared to historical distributions may improve treatment-plan evaluation, e.g., “that value is higher than 93% of the previous 58 treatment-plans used to treat the same disease site with the same technique.”

Treatment plan optimization is used to create intensity modulated radiation therapy (IMRT) and volumetric modulated arc therapy (VMAT) plans for computer-controlled creation of optimal multi-leaf collimator (MLC) patterns as a part of patient-treatment delivery. The conventional approach for optimization is to manually set the location and priorities of constraints. An alternative optimization approach is to manually select a subset of favored plans and set constraints based the statistics of that subset. Unfortunately, these approaches also do not enable automatically incorporating historical experience as it evolves.

Developing an overall scoring approach that creates a model similar to NTCP, but which is based upon historical, clinical experience with discrete DVH metrics, may improve the ability to quantify inter-comparisons of treatment-plans.

### SUMMARY OF THE INVENTION

Embodiments of a system, method, or computer-readable medium described herein utilize historical patient data to assist patient treatment personnel, e.g., physician(s), in choosing an improved treatment dosage or method for an individual patient. By utilizing data structures describing advanced statistical and/or computational techniques, the historical patient data (for example, aggregate historical treatment-plan data of one or more other patients having characteristics similar to the individual patient) may be utilized to guide the physician to create a more appropriate patient treatment-plan for the individual patient.

The embodiments utilize adaptive statistical calculations to evaluate an individual patient's treatment-plan compared to an aggregate of historical patient data corresponding to the treatment-plan. More specifically, the physician may analytically evaluate the patient-treatment-plan by examining the patient data with respect to a selected evaluation metric. The physician may modify the patient treatment-plan based on the evaluation with the selected evaluation metric. Further, the evaluation method is adaptive to receiving additional historical patient data for continual consideration and adjustment of the patient treatment-plan evaluation.

In accordance with one example aspect of the described embodiment directed to facilitating treatment of a patient by generating a display to improve decision making for treatment options of a patient, a method executed on a system including one or more operatively coupled processors, a memory component, and a user interface including a display screen, comprises: receiving, at the one or more processors, patient data associated with a treatment-plan for the patient; providing a patient data structure describing a conventional dose volume histogram associated with the treatment-plan for the patient; rendering, by the one or more processors, an image of the conventional dose volume histogram; receiving, at the one or more processors, aggregate historical patient data associated with the treatment-plan for at least one historical patient; providing an aggregate historical patient data structure describing a statistical historical patient dose volume histogram associated with an experience of the treatment-plan for the at least one historical patient; rendering, by the one or more processors, an image of the statistical patient dose volume histogram; and displaying, by the one or more processors, the rendered images of the conventional dose volume histogram and the statistical dose volume histogram on the display screen for visually evaluating treatment of the patient.

In accordance with another example aspect of the described embodiment directed to facilitating treatment of a patient by generating a display to improve decision making for treatment options of a patient, a method executed on a system including one or more operatively coupled processors, a memory component, and a user interface including a display screen, comprises: receiving, at the one or more processors, patient data associated with a treatment-plan for the patient; receiving, at the one or more processors, aggregate historical patient data associated with the treatment-plan for at least one historical patient; providing a correlation data structure including the patient data and the aggregate historical patient data, wherein the correlation data structure describes a correlation between the patient data and the aggregate historical patient data based on a selected evaluation metric; rendering, by the one or more processors, an image of the correlation between the patient data and the aggregate historical patient data based on the selected evaluation metric; and displaying, by the one or more processors, the rendered image of the correlation between the patient data and the aggregate historical patient data on the display screen for visually evaluating treatment of the patient.

In accordance with a further example aspect of the described embodiment directed to facilitating treatment of a patient by generating a display to improve decision making for treatment options of a patient, a system includes one or more processors; a display device coupled to the one or more processors; a memory coupled to the one or more processors; a patient data structure stored on the memory and describing a conventional dose volume histogram associated with the treatment-plan for the patient; a historical patient data structure stored on the memory and describing a statistical patient dose volume histogram associated with the experience of the treatment-plan for the at least one other patient; a correlation data structure stored on the memory and describing a correlation between the patient data and the aggregate historical patient data based on a selected evaluation metric; and instructions stored on the memory that when executed by the one or more processors, cause the system to: receive patient data associated with a treatment-plan for the patient; render an image of the conventional dose volume histogram; receive aggregate historical patient data associated with an experience of the treatment-plan for at least one other patient; render an image of the statistical patient dose volume histogram; display the rendered images of the conventional dose volume histogram and the statistical dose volume histogram on the display screen for visually evaluating treatment of the patient.

In accordance with a further example aspect of the described embodiment directed to facilitating treatment of a patient by generating a display to improve decision making for treatment options of a patient, a method executed on a system including one or more operatively coupled processors, a memory component, and a user interface including a display screen, comprises: receiving, at the one or more processors, patient data associated with a treatment-plan for the patient; receiving, at the one or more processors, aggregate historical patient data associated with the treatment-plan for at least one historical patient; constructing a general evaluation metric; providing a correlation data structure including the patient data and the aggregate historical patient data, wherein the correlation data structure describes a correlation between the patient data and the aggregate historical patient data based on the constructed general evaluation metric; rendering, by the one or more processors, an image of the correlation between the patient data and the aggregate historical patient data based on the constructed general evaluation metric; and displaying, by the one or more processors, the rendered image of the correlation between the patient data and the aggregate historical patient data on the display screen for visually evaluating treatment of the patient.

In accordance with a still further example aspect of the described embodiment directed to facilitating treatment of a patient by generating a display to improve decision making for treatment options of a patient, a method executed on a system including one or more operatively coupled processors, a memory component, and a user interface including a display screen, comprises a method of facilitating treatment of a patient, the method executed on a system including one or more operatively coupled processors, a memory component, and a user interface including a display screen, the method comprising: receiving, at the one or more processors, historical patient treatment-plan data associated with a treatment-plan for a plurality of patients, the historical patient treatment-plan data including a dose volume histogram curve based on statistical information relating to a treatment-plan constraint parameter threshold value and an associated priority value; creating, by the one or more processors, an individual patient treatment-plan for an individual patient based on the historical patient treatment-plan data (such as, intensity modulated radiotherapy (IMRT) and/or volumetric modulated arc radiotherapy (VMAT)); treating the individual patient based on the created individual patient treatment-plan; monitoring, by the one or more processors, a response of the individual patient to the individual patient treatment-plan in comparison to the received historical patient treatment-plan data; receiving additional historical patient treatment-plan data; automatically updating, at the one or more processors, the historical patient treatment-plan data based on the received additional historical patient treatment-plan data; adjusting, by the one or more processors, the individual patient treatment-plan based on the updated historical patient treatment-plan data; and treating the individual patient based on the adjusted individual patient treatment-plan.

### BRIEF DESCRIPTION OF THE DRAWINGS

FIG. 1 is a flow diagram illustrating one embodiment of the embodiment described herein directed to facilitating treatment of a patient.

FIG. 2 is a patient-treatment chart illustrating patient data for an individual patient including a conventional dose volume histogram (DVH).

FIG. 3 is a patient-treatment chart illustrating aggregate patient data including a statistical dose volume histogram (DVH) for one or more historical patients with matching characteristics of the individual patient.

FIG. 4 is a chart illustrating the simultaneous display of the conventional DVH curve shown in FIG. 2 with the statistical DVH curve shown in FIG. 3.

FIG. 5 is a chart illustrating a box and whiskers plot graph of the comparison of the individual patient data to the aggregate historical patient data with respect to an evaluation metric, for example, normal tissue complication probability (NTCP).

FIGS. 6A-6I depict a patient treatment-plan dashboard including the comparison chart of FIG. 4 for the individual patient and several box-and-whiskers plot graphs depicting the comparison of individual patient data to the aggregate historical patient data with respect to one of several evaluation metrics, for example, NTCP in FIG. 6B, monitor unit (MU) per Gray value (Gy) in FIG. 6C, and various volume percentages of Gray, e.g., V50Gy[%] in FIG. 6G, V60Gy[%] in FIG. 6F, V70Gy[%] in FIG. 6E, V75Gy[%] in FIG. 6D; or volume cubic centimeters, e.g., V65Gy[cc] in FIG. 6I, V75Gy[cc] in FIG. 6H.

FIGS. 7A-7I depict a patient treatment-plan dashboard similar to that shown in FIGS. 6A-6I, but for another patient and the another patient's corresponding box and whiskers plot graphs depicting the comparison of the another patient's data to the aggregate historical patient data with respect to one of several evaluation metrics, for example, NTCP in FIG. 7B, monitor unit (MU) per Gy in FIG. 7C, and various volume percentages of Gray, e.g., V50Gy[%] in FIG. 7G, V60Gy[%] in FIG. 7F, V70Gy[%] in FIG. 7E, V75Gy[%] in FIG. 7D; or volume cubic centimeters, e.g., V65Gy[cc] in FIG. 7I, V75Gy[cc] in FIG. 7H.

FIG. 8 depicts a flow diagram relating to another embodiment described herein directed to facilitating treatment of a patient based on a selected evaluation metric.

FIGS. 9A and 9B depict graphs relating to the calculation of the probability of each Dx %[Gy] value for a selected evaluation metric (for example, NTCP) for an individual patient that is greater than or equal to the corresponding Dx %[Gy] value of the selected evaluation metric for the aggregate historical patient data.

FIGS. 10A and 10B depict graphs related to determining the portions of the statistical DVH curve that correlate more strongly to the selected treatment metric (for example, NTCP).

FIGS. 11A and 11B depict graphs related to determining weighting factors to highlight undesirable features of the graph portions identified as more strongly correlating with the selected evaluation metric (for example, NTCP).

FIGS. 12A, 12B, and 12C depict graphs related to determining a weighted experience score (WES) based on the selected evaluation metric (for example, NTCP).

FIGS. 13A, 13B, and 13C depict the combined conventional individual patient DVH and aggregate historical patient statistical DVH chart; a box-and-whiskers plot chart depicting the evaluation of the combined DVH charts of FIG. 13A with respect to the selected evaluation metric (for example, NTCP); and the calculated weighted evaluation score for an individual patient (for example, Patient A) with respect to the selected evaluation metric (for example, NTCP), respectively.

FIGS. 14A, 14B, and 14C depict the corresponding charts of FIGS. 13A, 13B, and 13C for another individual patient (for example, Patient B).

FIGS. 15A-15E depict plot charts illustrating thresholds of the weighted selected evaluation (WES) metric compared to another evaluation metric.

FIG. 16 is a flow diagram for facilitating treatment of a patient utilizing a generalized evaluation metric (GEM).

FIG. 17 depicts a chart illustrating discrete evaluation constraint parameters and associated levels of priority provided by patient-treatment personnel.

FIG. 18 depicts a graph of a sigmoidal curve function, e.g., an error function, a logit function, a logistic function; utilized in the determination of the general evaluation metric (GEM).

FIGS. 19A and 19B depict charts related to determining weighting factors (FIG. 19B) to highlight undesirable features of the graph portions identified as more strongly correlating with the general evaluation metric (GEM) (FIG. 19A) with respect to a first set of constraint parameters.

FIGS. 20A and 20B depict charts related to determining weighting factors (FIG. 20B) to highlight undesirable features of the graph portions identified as more strongly correlating with the general evaluation metric (GEM) (FIG. 20A) with respect to a second set of constraint parameters.

FIG. 21 depicts a statistical DVH, wherein constraint parameter values (e.g., Dx %[Gy]) have been incorporated into the intensity modulated radiation therapy (IMRT) and/or volumetric modulated arc therapy (VMAT) treatment plan optimization at locations determined from statistical DVH and with weights based on the associated priorities determined by the general-evaluation-metric weighted-experience-score (GEM WES).

FIG. 22 depicts a table for planning objectives typically specified by physicians as a set of threshold values and integer values expressing prioritization.

FIG. 23 depicts an example statistical DVH dashboard quantifying comparison of statistical metrics for the current plan vs. historical experience; wherein statistical DVH may be compared to historical experience for the median (dashed line), 50% CI, 70% CI and 90% CI; box and whisker plots may provide comparisons of a plan level (left panel) and structure level (right panel) metrics.

FIGS. 24A and 24B illustrate the use of the statistical DVH and metrics to compare DVH curves for one patient plan (e.g., Plan 1) with low WES scores for Uninvolved vs. Involved parotid structures.

FIGS. 25A and 25B illustrate the use of the statistical DVH and metrics to compare DVH curves for another patient plan (e.g., Plan 2) with high WES scores for Uninvolved vs. Involved parotid structures.

FIG. 26 illustrates decomposition and comparison of two plans from head and neck cohort. Two plans of different difficulty levels, overall plan GEM at median (plus, +) and upper 90% CI (diamond, 0), are detailed by GEM scores of each threshold-priority constraint (missing data indicates structure not being contoured in that plan). Box-and-whisker plots have their whiskers located at 5% and 95% quantiles of the GEM scores; and corresponding metric values are tabled in the right columns of Metric Quantiles.

FIG. 27 illustrates decomposition and comparison of two plans from prostate cohort, with ALARA constraints involved, wherein ALARA thresholds (constraint values) may be set to be the medians of their corresponding metric values, with an assigned priority 4 shown in a shaded row for Rectum-V75Gy[%] constraint, which has median 0 Gy and a small number 0.1 is used as the threshold.

FIGS. 28A, 28B, and 28C illustrate comparisons of statistical metrics for heart doses in a Liver SBRT patient treated with 5 fractions.

FIGS. 29A-29E depict comparisons of NTCP, WES, GEM and GEMₚₒₚ scores vs. mean dose for non-involved parotids.

FIGS. 30A-30E depict comparisons of NTCP, WES, GEM and GEMₚₒₚ scores vs. mean dose for involved parotids.

FIG. 31 illustrates a block diagram of an example network and computer hardware that may be utilized with a system and/or method in accordance with the described embodiments.

FIG. 32 illustrates a block diagram of an example computer system on which a system and method may operate in accordance with the described embodiments.

### DETAILED DESCRIPTION

The systems, methods, and computer-readable medium described herein utilize past experience patient data of aggregated historical patients to evaluate a treatment-plan of an individual patient with similar characteristics to the aggregated historical patients. Database systems provide for routine aggregations of data reflecting historical experience and embodiments described herein utilize the evolution of the historical experience to enable evaluation and optimization of a treatment plan. In particular, statistical DVH-based metrics and visualization methods are utilized to quantify a comparison of treatment plans against historical experience as well as among different institutions. For example, a descriptive statistical summary (median, 1st and 3rd quartiles, and 95% confident interval) of volume-normalized DVH curve sets of past experience are visualized in the creation of statistical DVH plots. Detailed distribution parameters are calculated and a to-be-evaluated full-length DVH curve may be scored against statistical DVH as weighted experience score (WES). Individual clinically-used DVH-based metrics are integrated into one generalized evaluation metric (GEM, GEMₚₒₚ), as a priority-weighted sum of normalized incomplete gamma functions. A shareable dashboard (plugin) is capable of displaying statistical DVH and integrate WES, GEM, and GEMpop scores into a clinical plan evaluation wherein benchmarking/comparison with NTCP scores may be carried out to assure the sensibility of WES, GEM, and GEMₚₒₚ scores. Statistical DVH offers a detailed easy-to-read, yet comprehensive way to visualize the quantitative comparison to historical experience and among multi-institutions. WES, GEM, and GEMₚₒₚ metrics offer flexible/adoptive measures in studying the fast-evolving dose-outcome relationship being revealed by big data transition in radiation oncology.

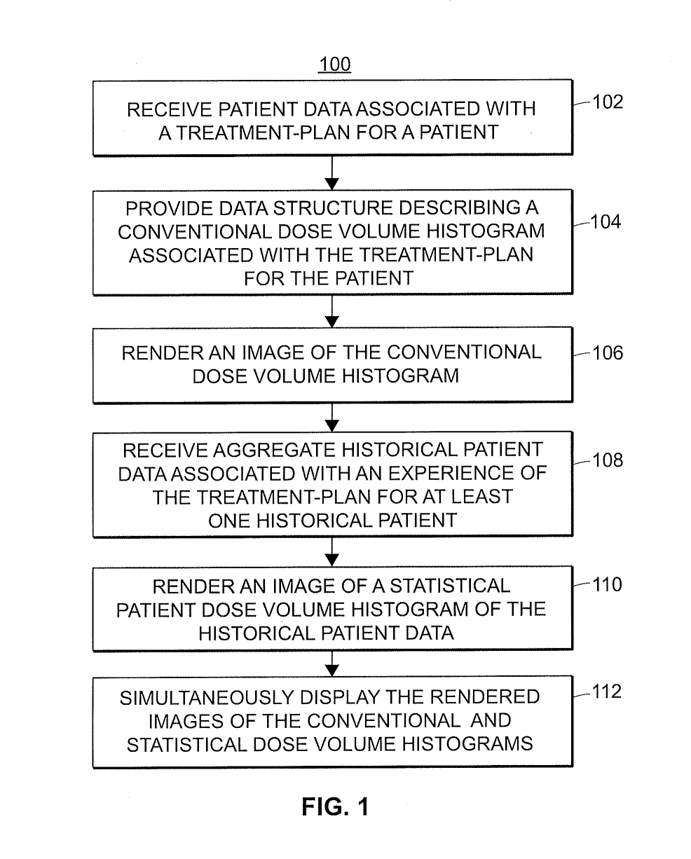

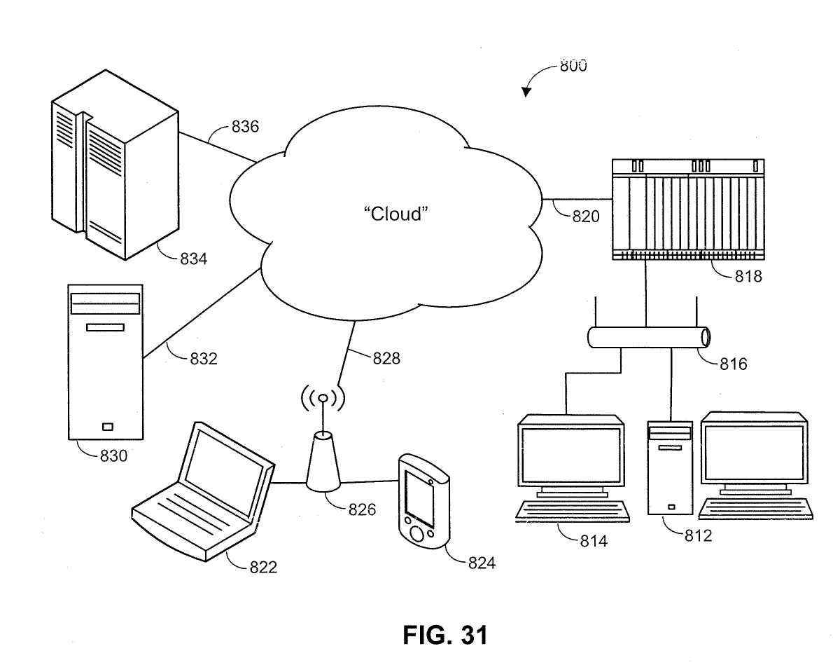

FIG. 1 is an example method 100 of facilitating treatment of a patient by providing a display to improve decision making for treatment options of a patient with a medical condition. The method 100 is executed on a system that may include one or more operatively coupled processors, a memory component, and a user interface including a display screen; an example of which is later described in relation to FIGS. 30 and 31. The method 100 receives patient data associated with a treatment-plan for the patient (block 102). A patient data structure describing a conventional dose volume histogram associated with the treatment-plan for the patient is provided (block 104) for rendering an image of the conventional dose volume histogram (block 106). Aggregate historical patient data associated with an experience of the treatment-plan for at least one historical patient is received (block 108), wherein a historical patient data structure describing a statistical dose volume histogram associated with the experience of the treatment-plan for the at least one historical patient utilizes the aggregate historical patient data to render an image of the statistical patient dose volume histogram (block 110). The rendered images of the conventional dose volume histogram and the statistical dose volume histogram are simultaneously displayed on the display screen (block 112) for visual evaluation of the patient treatment-plan by treatment personnel, e.g., physician.

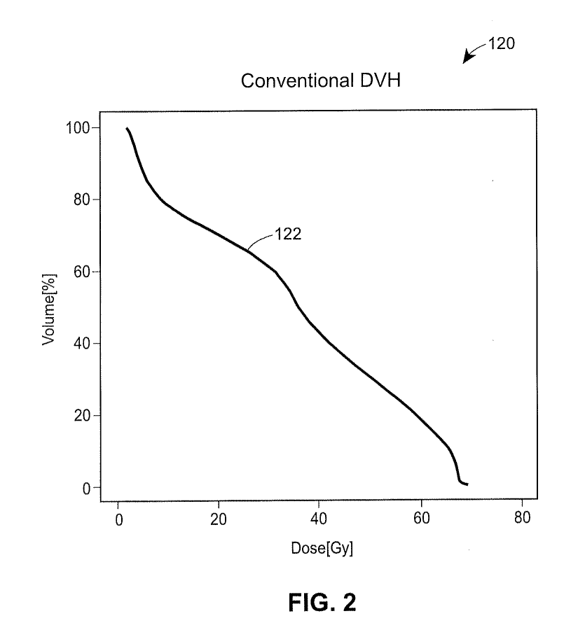

FIG. 2 is an example embodiment of the patient data associated with a treatment-plan for a patient that includes a conventional dose volume histogram (DVH) 120 related to a prostate treatment-plan. The DVH 120 includes patient data depicted as a curved line 122 within the conventional DVH 120 for a particular patient. The patient data 122 includes volume percentage (Volume[%], (Y-axis)) and Dose Gray (Dose[Gy], (X-axis)); that is, Dx %[Gy].

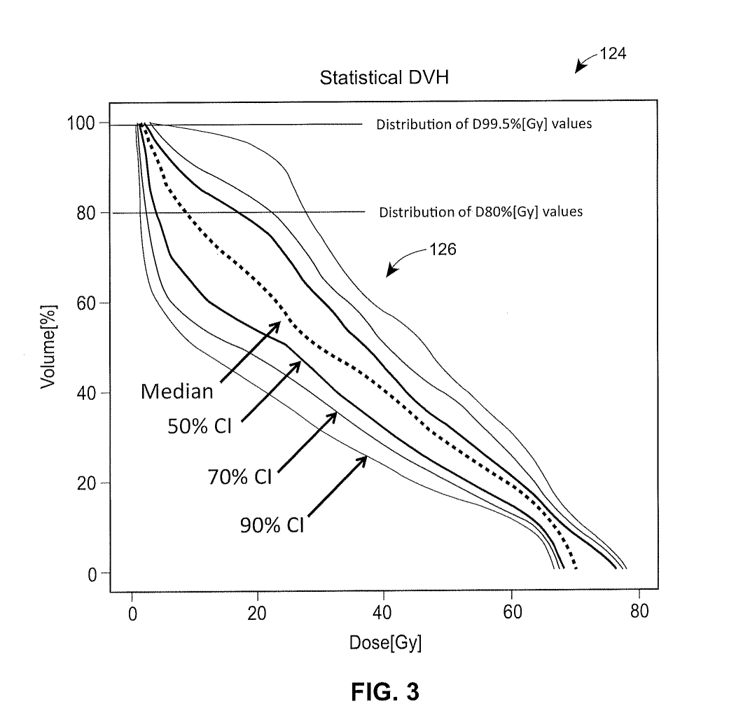

A statistical dose volume histogram (DVH) 124 for a population of other patients with substantially matching characteristics of the individual patient is plotted in the statistical DVH 124 shown in FIG. 3. The graph distribution includes a distribution of statistical DVH curves of the aggregated patient data 126 of the other patients based on the treatment-plan. The statistical DVH 124 may include a median and confidence interval (CI) envelops (e.g., 50%, 70%, 90%) for Dx %[Gy] values. Computed statistics on Dx %[Gy] at fixed sets of percentage points may also be shown in the statistical DVH graph 124.

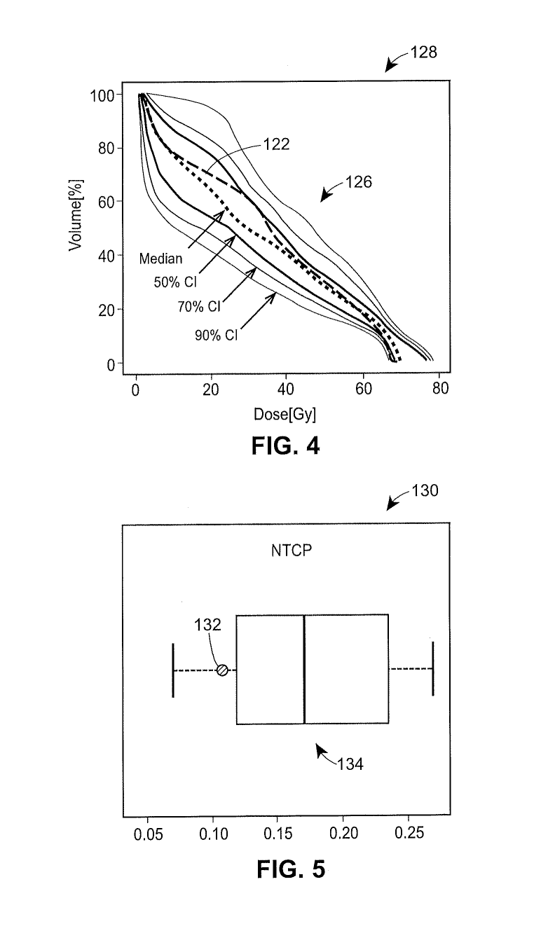

Statistical DVH is utilized to quantify comparison of individual DVH curves with historical experience. FIG. 4 depicts the simultaneous display 128 of the patient data 122 of the conventional DVH 120 shown in FIG. 2 and the aggregate historical patient data 126 of the statistical DVH 124 shown in FIG. 3. By overlaying the conventional DVH 120 and the statistical DVH 124, physicians may more readily evaluate the individual patient data 122 in the context of the statistical DVH 124 of the aggregated historical patient data 126 and treat the patient accordingly. Rather than the traditional format of volume values stored at equally spaced dose intervals, the DVH curves are presented in a volume-focused format. Absolute dose values (Gy) for a set, e.g., 31, variably spaced (0.5%, 1%, 5% increments) fractional volumes (100%, 99.5%, 99%-96% by 1% step size, 95%-5% by 5% step size, 4%-1% by 1% step size, 0.5%, 0%) were stored as a set of (Dx %[Gy], x %) dose-volume pairs, along with structure volumes and a standard set of DVH metrics including: Max[Gy], Min[Gy], Mean[Gy], Median[Gy], D0.5cc[Gy], DC0.5cc[Gy]. This format facilitates construction of the statistical representation of DVH curves and assures the ability to represent DVH curves independent of the dose scale, e.g., Max[Gy], with a small, fixed set of points.

Patient treatment-plans are routinely evaluated in the context of an evaluation metric, such as: normal tissue complication probability (NTCP), tumor control probability (TCP), monitor unit per Gray (MU/Gy), dose volume histogram or radiobiological plan evaluation metrics, and/or dose volume distribution Gray (Dxcc[Gy]), which are typically used to calculate the DVH curve. FIG. 5 depicts a box-plot 130 or box-and-whiskers graph readily depicting an evaluation of the patient treatment-plan for an individual patient in the context of NTCP and in comparison with the aggregate historical patient data of the at least one other patient also in context of NTCP. The box-and-whiskers graph 130 shows the individual patient data (represented by a point 132) in relation to the historical patient data gathered from the treatment-plan experience of the aggregated historical patients (represented by a box-and-whiskers 134). The whiskers are assigned to a high confidence interval for the distribution (e.g., 95% CI or 90% CI) to prevent anomalous, outlier values from skewing the evaluation.

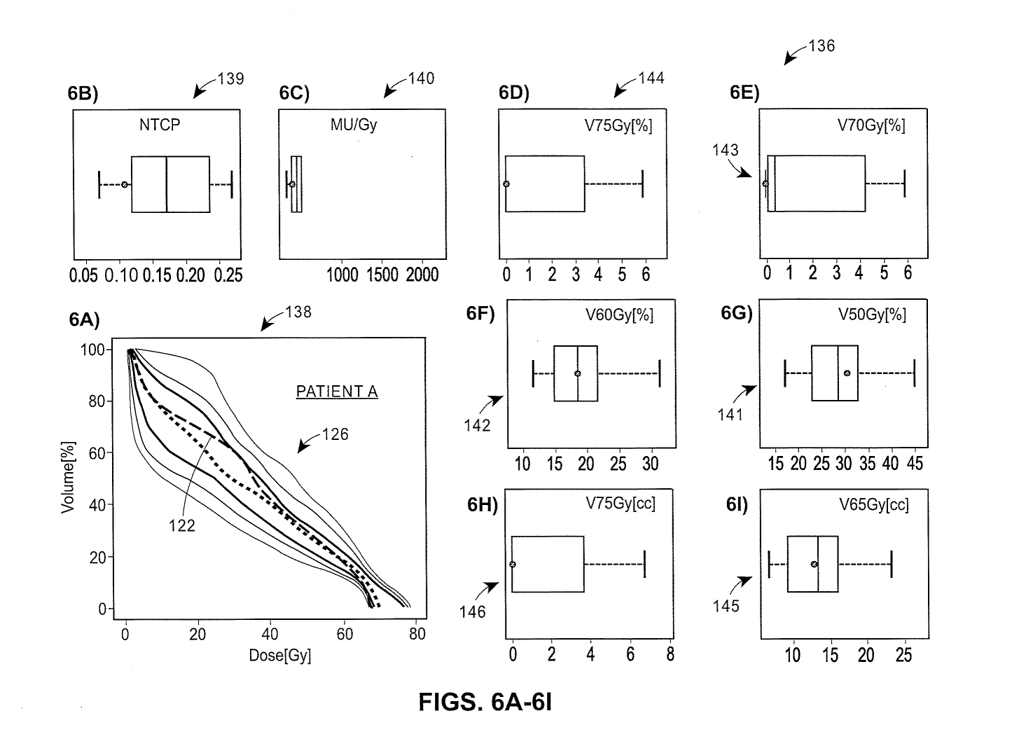

Patient data deemed relevant by treatment personnel may be displayed in a statistical dashboard for visualizing patient data curves and historical experience in the context of various evaluation metrics. An example dashboard for a first patient, Patient A, is illustrated in FIGS. 6A-6I. The dashboard 136 includes a graph 138 depicting the simultaneous display of the patient data curve 122 of the conventional DVH for Patient A and the aggregate historical patient data curves 126 of the statistical DVH in FIG. 6A. The dashboard 136 also includes other diagrams (e.g., box plots) depicting the patient data of Patient A and the aggregate historical patient data in the context of the evaluation metric, such as, NTCP 139 in FIG. 6B, monitor unit (MU) per Gray value (Gy) 140 in FIG. 6C, and various dose volume histogram metrics, e.g., V50Gy[%] 141 in FIG. 6G, V60Gy[%] 142 in FIG. 6F, V70Gy[%] 143 in FIG. 6E, V75Gy[%] 144 in FIG. 6D; or volume cubic centimeters, e.g., V65Gy[cc] 145 in FIG. 6I, and V75Gy[cc] 146 in FIG. 6H.

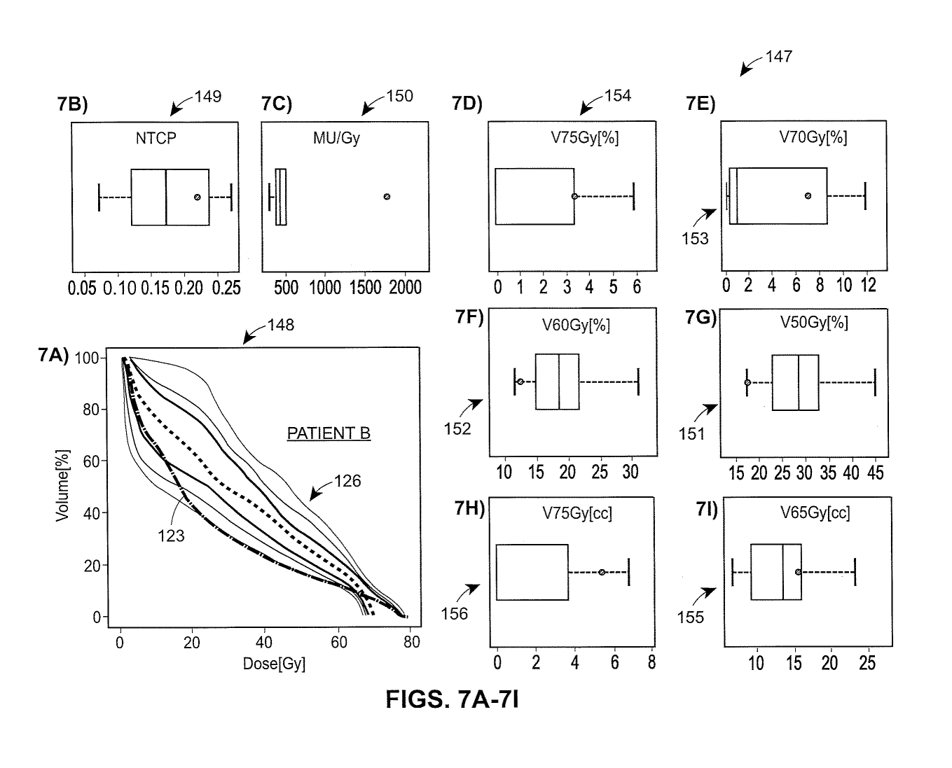

Additional statistical dashboards may be constructed for the at least one other individual patient. For example, another dashboard 147 is shown in FIGS. 7A-7I for a second patient, Patient B. The dashboard 147 includes a graph 148 illustrating a patient data curve 123 of the conventional DVH curve for Patient B, and statistical DVH curves 126 for the aggregate historical patient data of the at least one other patient in FIG. 7A. The dashboard 147 may include box plots similar to those depicted in FIGS. 6A-6I, but corresponding to the characteristics of the patient data for Patient B, for example, NTCP 149 in FIG. 7B, monitor unit (MU) per Gy 150 in FIG. 7C, and various dose volume histogram metrics, e.g., V50Gy[%] 151 in FIG. 7G, V60Gy[%] 152 in FIG. 7F, V70Gy[%] 153 in FIG. 7E, V75Gy[%] 154 in FIG. 7D; or volume cubic centimeters, e.g., V65Gy[cc] 155 in FIG. 7I, and V75Gy[cc] 156 in FIG. 7H.

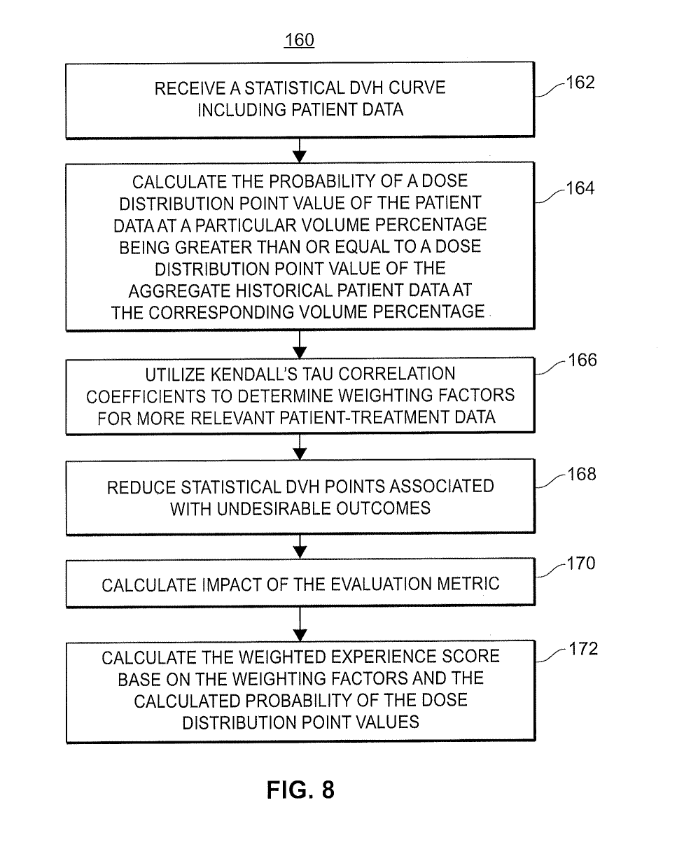

For some patient treatment-plans, not all patient data reflected in the conventional DVH may be considered relevant or equally relevant. In radiology oncology, for example, physicians are more concerned with higher dose data than lower dose data. In such instances, it is beneficial to add weight to the more relevant parts of the DVH as compared to the less relevant parts of the DVH. FIG. 8 depicts a flow chart for a method 160 for developing an evaluation metric capable of reflecting the historical experience of the patient treatment-plan with that which may be achieved and/or desired values. The method 160, which may be executed on a system including one or more operatively coupled processors, a memory component, and a user interface including a display screen, includes receiving a statistical DVH curve including patient data (block 162) related to dose Gray and volume percentage (i.e., Dx %[Gy]) and aggregate historical patient data relating to dose Gray and volume percentage. The method 160 includes calculating the probability of a dose distribution point value of the patient data at a particular volume percentage being greater than or equal to a dose distribution point value of the aggregate historical patient data (i.e., sample) at the corresponding volume percentage (block 164). To weight the more relevant data, Kendall's tau correlation coefficients are used to determine those parts of the statistical DVH curve that correlate more strongly to a selected evaluation metric, for example, NTCP (block 166). To reduce or eliminate statistical DVH points associated with undesirable outcomes, weighting factors are utilized, wherein any Kendall's tau correlation coefficients less than zero are set equal to zero (block 168). The impact on NTCP may be reflected by the product of the weighting factor (i.e., positive Kendall's tau correlation coefficients) and the probability of the individual patient's values (i.e., Dx %[Gy]) that are greater than or equal to the corresponding aggregate historical patients' values (block 170).

The values of the resulting product of the weighting factors and probabilities may be summed to create a weighted experience score (WES) (block 172). The WES provides a single numerical value for assessing comparison of the present DVH curve within the context of historical experience. It is calculated by evaluating the weighted cumulative probability (pi) of historical Dx %[Gy] values being less than or equal to that of the present treatment plan. The magnitude of the components of the first eigenvector from principal component analysis (PCA) of the Dx %[Gy] set is used to define weighting factor coefficients (wpcaᵢ) emphasizing Dx %[Gy] values which have the largest impact on minimizing co-variance in data set values. Volume intervals spacing the Dx %[Gy] points define weighting values for bin width (wbᵢ).

$$WES = \frac{{\sum }_{i}^{ } {wb}_{i}^{*} {wpca}_{i}^{*} {p}_{i}}{{\sum }_{i}^{ } {wb}_{i}^{*} {wpca}_{i}}$$

For weighting factors calculated using correlations with an evaluation metric, such as NTCP in this example, the weighted experience score (WES) may be referred to as NTCP WES.

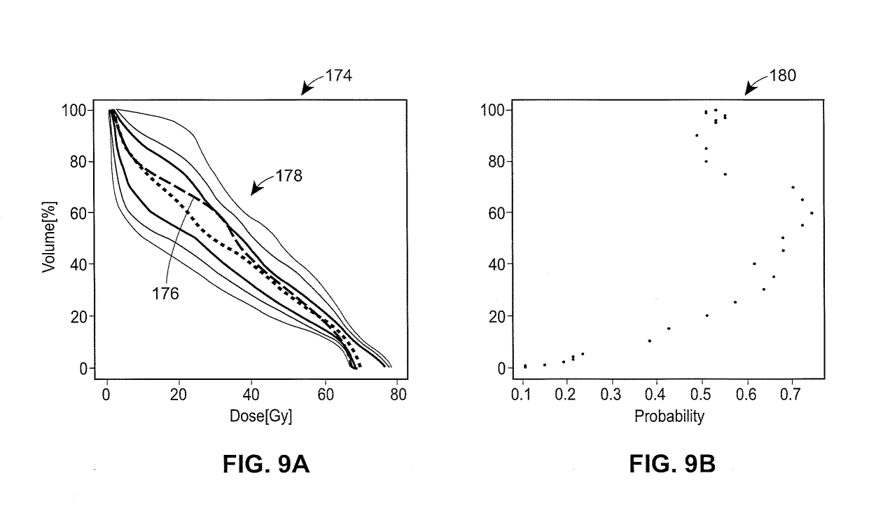

FIGS. 9A and 9B correspond to the initial steps of the method 160 illustrated in FIG. 8 wherein FIG. 9A includes the conventional and statistical DVH curves correlation 174 (illustrated 128 earlier in FIG. 4) with the NTCP evaluation metric. The probabilities 180 that dose values at a fractional volume (Dx %[Gy]) for the individual patient exceed the historical values for other historical patients of comparable patient treatment-plans are shown in FIG. 9B. It can be observed in FIG. 9A near the higher dose values toward the right side of the DVH curves, the Dx %[Gy] for the individual patient with high Dose[Gy] value is generally less than the Dx %[Gy] for the dose values of the other historical patients. Therefore, the probability of the individual patient's value of Dx %[Gy] being greater than or equal to probability of the historical patients' value of Dx %[Gy] is lower, as can be observed in FIG. 9B. In contrast, it can be seen in the middle portion of the DVH curves of FIG. 9A that the probability of the individual patient's value of Dx %[Gy] being greater than or equal to probability 180 of the historical patients' value of Dx %[Gy] is higher, as shown in FIG. 9B.

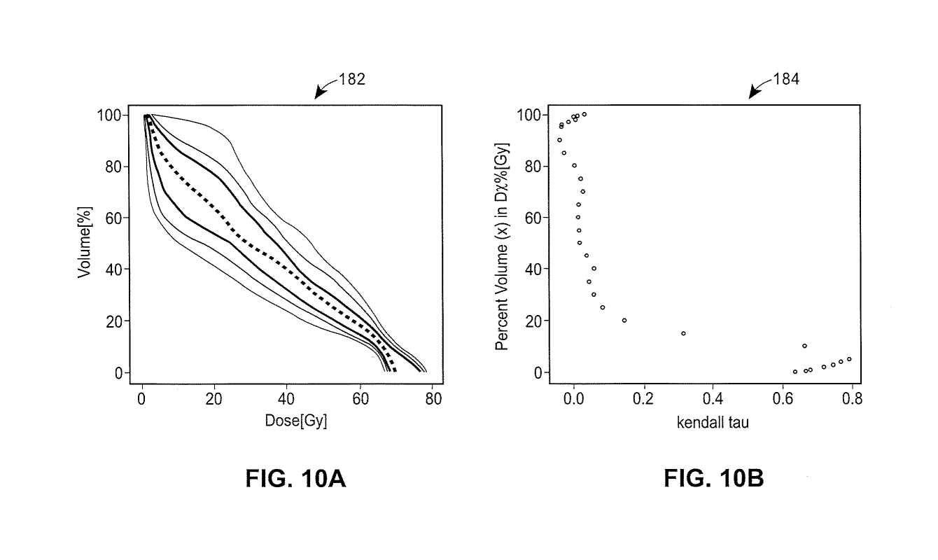

FIGS. 10A and 10B correspond to the steps of the method 160 illustrated in FIG. 8 for determining those parts of the statistical DVH curve 182 (illustrated 124 earlier in FIG. 3) that correlate more strongly to the NTCP metric for all patients. As noted earlier, all parts of the statistical DVH curve 182 may not be considered to be equally clinically relevant by patient treatment personnel. For example, high dose values of the statistical DVH curve 182 shown in FIG. 10A correlate more strongly to NTCP. Kendall's tau correlation coefficients 184 for correlating the historical values of dose-volume points with the NTCP evaluation metric are calculated and shown in FIG. 10B.

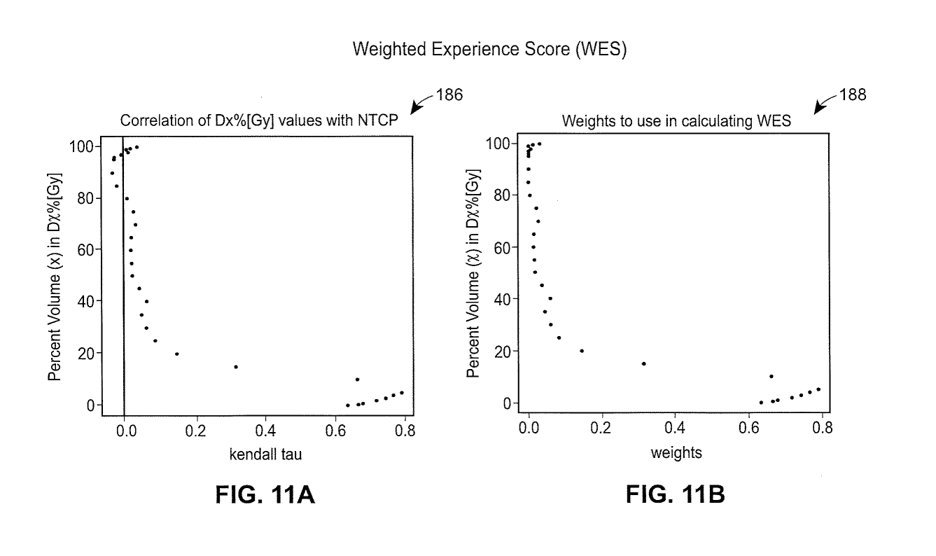

FIGS. 11A and 11B correspond to the steps of the method illustrated in FIG. 8 for utilizing weighing factors to reduce or eliminate statistical DVH points associated with undesirable outcomes. Kendall's tau correlation coefficients 186 that are less than zero are shown to the left of the vertical line aligned with the Kendall's tau value of 0.0 shown in FIG. 11A. Any Kendall's tau values less than zero, for example, to the left of the vertical line, is set to zero. The weighted Kendall's tau values 188 are shown FIG. 11B.

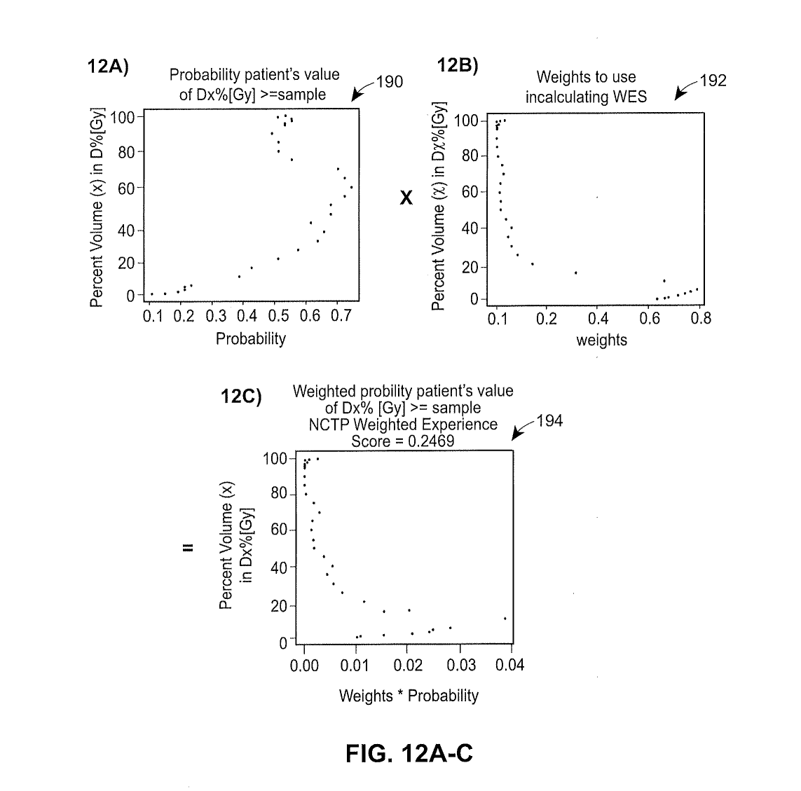

FIGS. 12A, 12B, and 12C correspond to the steps in the method illustrated in FIG. 8 for determining a weighted experience score (WES), wherein the product of the probability 190 of the individual patient's values (i.e., Dx %[Gy]) that are greater than or equal to the corresponding aggregate historical patients' values shown in FIG. 12A (illustrated 190 earlier in FIG. 9B) and the weighting factors 192 (i.e., determined by the positive Kendall's tau correlation coefficients) shown in FIG. 12B (illustrated 188 earlier in FIG. 11B) result in the weighted probability 194 of patient's values of Dx %[Gy] greater than or equal to the sample of the aggregate historical patients' values shown in FIG. 12C.

The weighted probability patient's values may be added together to determine the weighted experience score (WES), i.e., 0.2469. More specifically, since the evaluation metric used to determine the weighting factors in this example was NTCP, this example may be identified as NTCP WES.

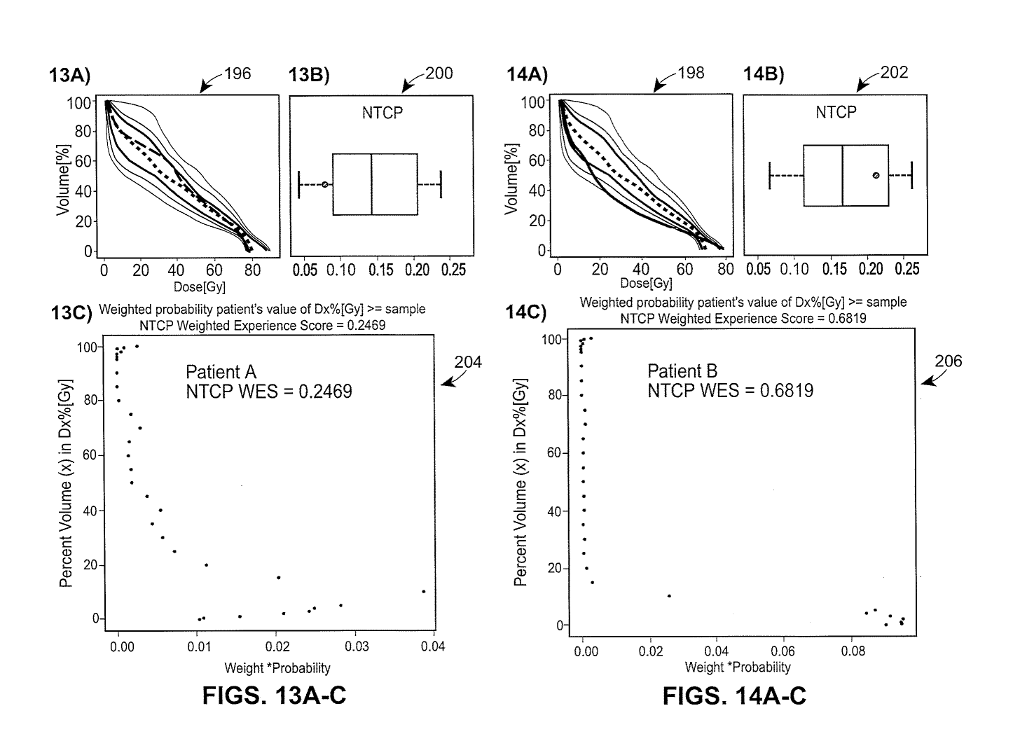

The single numerical score provided by the WES to characterize the individual patient treatment-plan in the context of historical experience with the ability to achieve the valued objective of the treatment-plan may be useful in comparing patient treatment-plans. In FIGS. 13A-13C and 14A-14C, evaluated treatment-plans with respect to the NTCP metric are shown for two patients—Patient A and Patient B, respectively. FIG. 13A is a graph illustrating Patient A's DVH 196 in comparison to aggregate historical statistical DVH data. Similarly, FIG. 14A is a graph illustrating Patient B's DVH 198 in comparison to aggregate historical statistical DVH data. The plot chart 200 depicted in FIG. 13B provides a numerical and visual comparison of Patient A's NTCP to aggregate historical statistical NTCP data. Similarly, the box plot 202 depicted in FIG. 14B provides a numerical and visual comparison of Patient B's NTCP to aggregate historical statistical NTCP data. FIG. 13C is a graph 204 depicting the weighted probability of Patient A's value of Dx %[Gy] being greater than or equal to the experience of the corresponding aggregate historical statistical patient data, as well as the numerical NTCP WES of Patient A. Similarly, FIG. 14C is a graph 206 depicting the weighted probability of Patient B's value of Dx %[Gy] being greater than or equal to the experience of the corresponding aggregate historical statistical patient data, as well as the numerical NTCP WES of Patient B. For comparing patient treatment-plans, the WES provides a single numerical score to characterize the patient treatment-plan in the context of historical patient treatment experience with the ability to achieve that which the treating physician values in the patient treatment-plan.

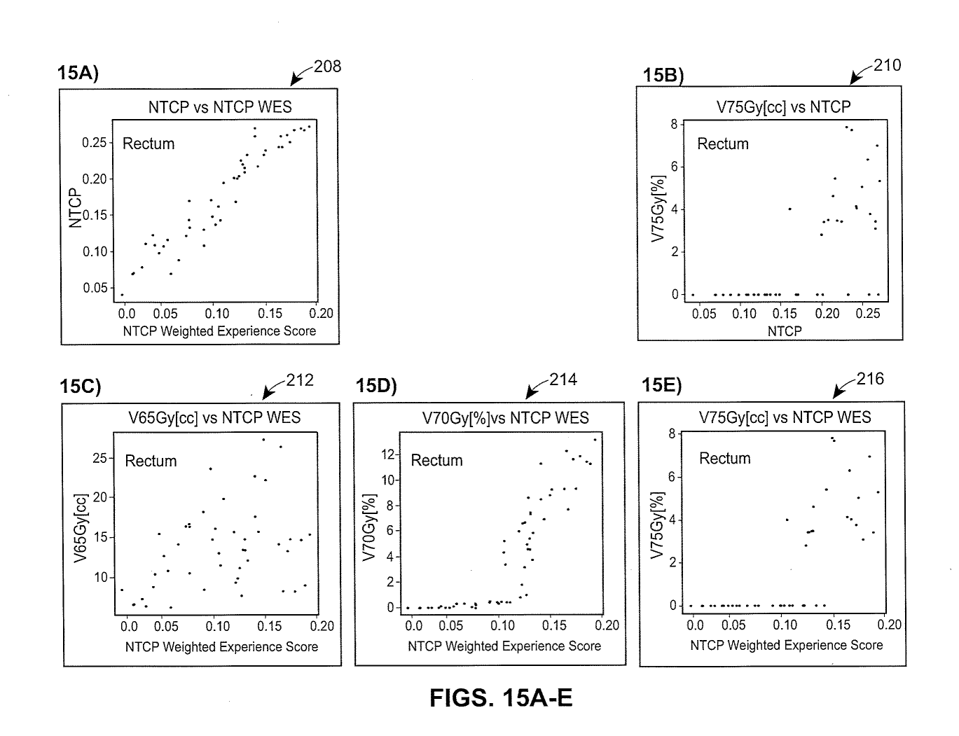

FIGS. 15A-15E depict charts 208, 210, 212, 214, 216 that illustrate thresholds and how an evaluation metric, e.g., NTCP WES, correlates with selected individual patient values that are a concern to the physician. For example, NTCP vs. NTCP WES 208 (FIG. 15A); V75Gy[cc] vs. NTCP 210 (FIG. 15B); V65Gy[cc] vs. NTCP WES 212 (FIG. 15C); V70Gy[k] vs. NTCP WES 214 (FIG. 15D); and V75Gy[cc] vs. NTCP WES 216 (FIG. 15E).

Thus far, points on the conventional and statistics DVH curves 128 have been correlated with an exemplary evaluation metric (e.g., NTCP) that reflects a respective evaluation of the conventional DVH curve. However, NTCP may not always be the factor of most concern to patient treatment personnel and there may be other factors that may matter more to patient treatment personnel that are not reflected in the NTCP calculation. Implementing a general purpose evaluation metric (GEM) that is designed to work with an arbitrary set of parameters may be helpful in determining other factors that are not reflected in the NTCP evaluation.

The general evaluation metric (GEM) may include Dx %[Gy], cost, radiation exposure, etc. It is preferable that such metrics be selected so that increasing values generally correspond to being less desirable. Similarly, an evaluation function used in determining the weighting factors from the Kendall's tau correlation coefficients is preferably arranged so that higher values correspond to being less desirable. From this, a generalized evaluation metric (GEM) can be formed and applied to a wide range of problems, dose related or non-dose related, that can be used to calculate the weighting factors with the Kendall's tau correlation coefficients to determine the overall weighted experience score (WES).

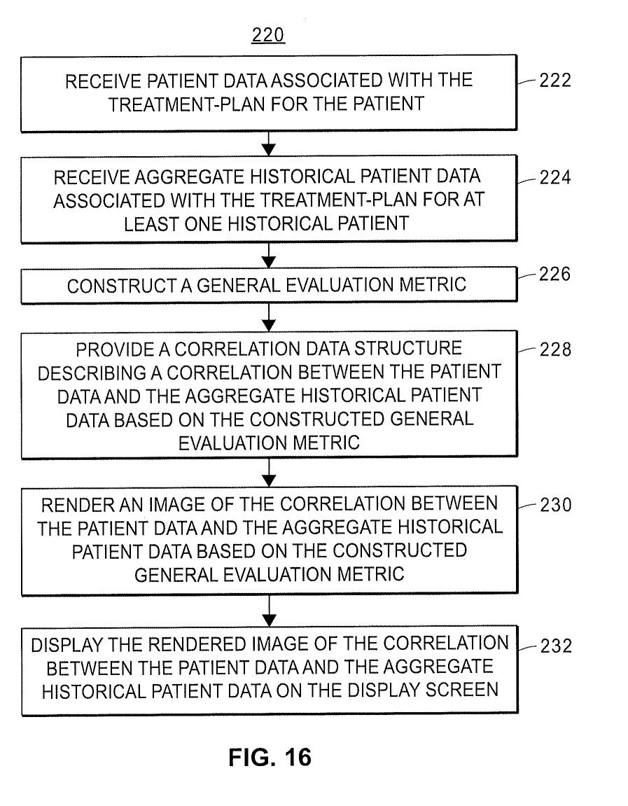

FIG. 16 illustrates an alternate method 220 for facilitating a treatment-plan of a patient by generating a display to improve decision making for treatment option of a patient. The method 220, which may be executed on a system including one or more operatively coupled processors, a memory component, and a user interface including a display screen, includes: receiving patient data associated with the treatment-plan for the patient (block 222); receiving aggregate historical patient data associated with the treatment-plan for at least one historical patient (block 224); constructing a general evaluation metric (block 226); providing a correlation data structure including the patient data and the aggregate historical patient data, wherein the correlation data structure describes a correlation between the patient data and the aggregate historical patient data based on the constructed general evaluation metric (block 228); rendering an image of the correlation between the patient data and the aggregate historical patient data based on the constructed general evaluation metric (block 230); and displaying the rendered image of the correlation between the patient data and the aggregate historical patient data on the display screen for visually evaluating the treatment-plan of the patient (block 232).

Constructing the general evaluation metric (GEM) may include: receiving at least one patient treatment constraint parameter and an associated priority level; providing a sigmoidal curve function, e.g., an error function, a logit function, a logistic function, for determining the general evaluation metric; calculating a general evaluation metric value for each patient value of the patient data based on the associated constraint parameter, the associated priority level, and the sigmoidal curve function; and calculating a general evaluation metric value for each aggregate historical patient value of the aggregate historical patient data based on the associated constraint parameter, the associated priority level, and the sigmoidal curve function.

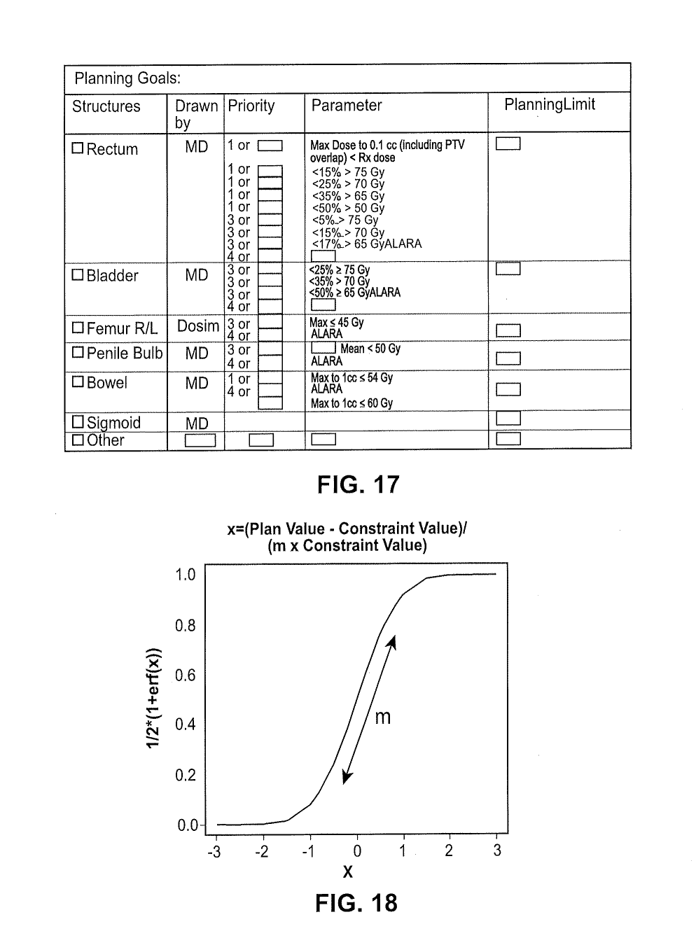

In FIG. 17, DVH objectives are generally expressed as discrete elements with prioritizations. In keeping with clinical practice, low numerical values for prioritization (e.g., 1) convey greater weight than higher values (e.g., 3). That is, a lower priority level value denotes higher importance over a higher priority level, and conversely, a higher priority level value denotes a lower importance as compared to a lower priority level value.

The GEM provides a continuous scoring value for a set of discrete threshold-priority constraints. Constraint parameters are typically DVH metrics, but may include radiobiological calculations or other parameters considered as part of the evaluation specified by a physician as relevant to the patient-treatment-plan. The constraint parameters are typically expressed as a threshold, i.e., greater than or less than a value or percentage; and formulated so that increasing values are associated with being less desirable (e.g., 1-TCP is used instead of TCP) to produce the same behavior for GEM values. The functional form of the GEM utilizes a sigmoidal curve with outputs ranging from 0 to 1 to score deviations from constraint values over the allowed range of plan values (>=0). GEM scores of [0, 0.5), 0.5 and (0.5, 1] corresponded to the plan values less than, equal to, or exceeding the constraint values.

The individual GEM values can be summed up over all constraints that the physician has applied as a way of constructing a generalized model based on the discrete elements to get a unique score. This is analogous to that described earlier with respect to the NTCP evaluation metric, except instead of the GEM being calculating from a single DVH curve, the GEM is calculated from a set of discrete metrics in the patient-treatment-plan, which can then be generalized for solving a range of problems.

Even though patient treatment personnel initially may not fully understand the continuous function of the general evaluation model (GEM) used to evaluate patient data, they will be knowledgeable of the parameter constraints and priorities that are used to construct the GEM. That is, the GEM constructs a continuous model based on historical data with discrete objectives and prioritizations, which provides a means to characterize behavior of a multifactor response model while details of an underlying mechanistic model are developing.

In short, the procedure for constructing the GEM score is analogous to that done with the NTCP, which was calculated from a single DVH curve, and the weighting function came from correlating with the NTCP and then used as the weighting factor to calculate WES. But, instead of calculating the NTCP, the GEM score is calculated and correlated with the Kendall's tau correlation coefficient to attain the weighting factor to construct the GEM weighted experience score (WES).

A graph of the example error function is shown in FIG. 18. In practice, a range of values that exceed any given constraint may be accepted, which is reflected with the slope parameter, m. The value of m is selected so that the upper 90% confidence interval (CI) value for the historical distributions of achieved values results in a GEM score of 0.95 for a priority of 1. If Upper 90% CI<Constraint Value, then a small value is selected to approximate a step function. Increasing numerical values for priority result in smaller weighting for the contribution to the GEM value.

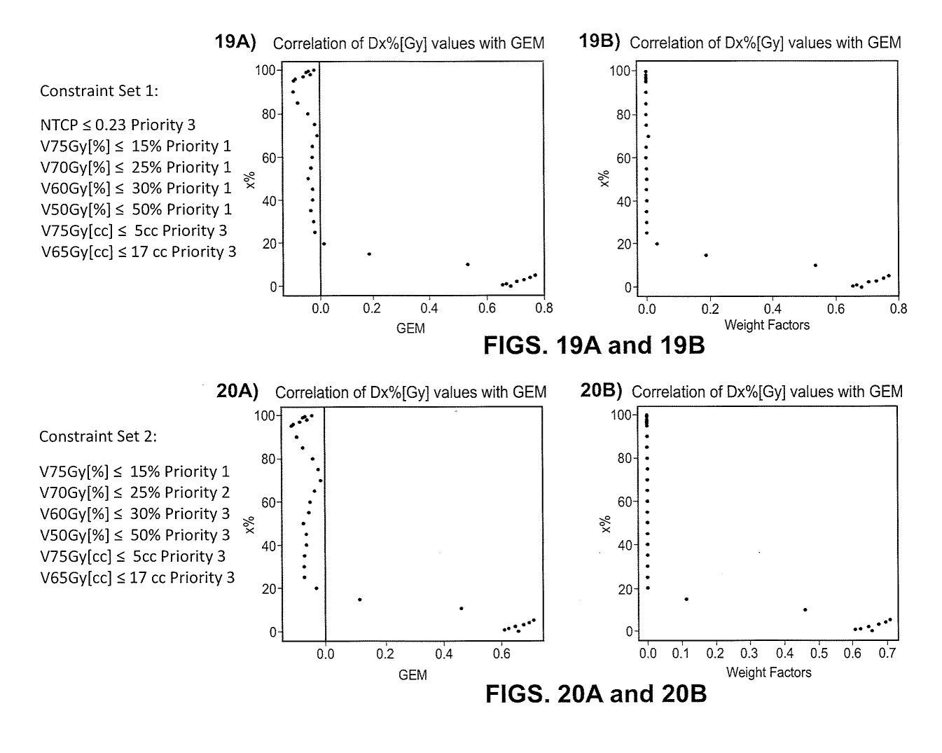

Referring now to FIGS. 19A-19C and 20A-20C, instead of using the NTCP evaluation metric, the GEM evaluation metric is used, which was generated from the discrete values (e.g., constraint parameters) selected and applied by patient-treatment personnel as being more relevant to the portions of the DVH curves for analysis. Multiple sets of discrete constraint parameters may be utilized for comparison of different models and the effect of applying different discrete values and/or prioritizations to one curve or another, i.e., Constraint Set 1 in FIGS. 19A and 19B and Constraint Set 2 in FIGS. 20A and 20B. Or, retrospectively patient-treatment personnel may analyze the patient data to determine the priorities for the selected constraint parameters values for alignment with the data, which may be a very useful way of modeling data to construct an analog function when all that may be known initially are discrete values and prioritizations.

Referring again to FIG. 17, the discrete constraint parameters and priorities may be unique to each physician or standardized among a practice group. If GEM scores were to be compared, the same constraint set should be used for calculating the GEM score. Typically, the priority value is arbitrarily assigned, for example, 1, 2, 3, or 4; but the priority value may be statistically based. To do so, the patient history is analyzed to determine the probability that the constraint parameter was met, and if so, it then becomes 2 to the power required to achieve that percentage. Or, if the priority value has yet to be assigned, the patient history data can be analyzed to select a priority value that corresponds with the patient-treatment experience. Additionally, if a priority value of a constraint parameter has been assigned, but the constraint parameter often times was not met, then the priority value may be changed, e.g., higher or lower, to be more in line with how the statistics have unfolded according to the patient treatment-plan.

Similarly, the slope parameter of the error function in FIG. 18 may be statistically based in view of the historical values experienced. For example, setting the value of m such that a GEM score of 0.95 corresponds to reaching the upper 95% confidence interval with respect to deviating from the constraint parameter value.

$$1 \text{/} 2 ( 1 + erf ( \frac{Upper 90 \% {CI}_{i} - Constraint {Value}_{i}}{{m}_{i} - Constraint {Value}_{i}} ) ) = 0.95 , Upper 90 \% {CI}_{i} > Constraint {Value}_{i}$$

$${m}_{i} = 0.05 , Upper 90 \% {CI}_{i} \leq Constraint {Value}_{i}$$

That is, forcing the values that would evaluate to 95% to be the same for both the GEM score and the confidence level based on selection of a slope parameter consistent thereto. Thus, the evaluation continues to reflect that which is of higher concern to the physician, as well as the statistics of the patient-treatment experience.

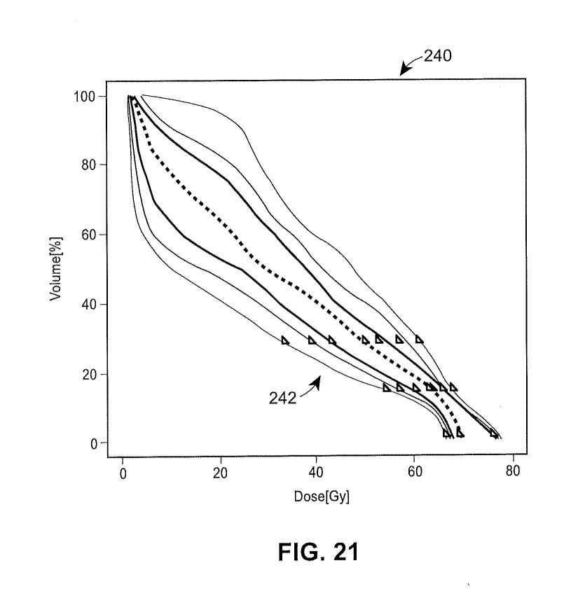

From the embodiments described herein, an improved system and process of coordinating and/or executing a patient treatment plan provides the capability to refer to historical patient treatment-plan experience when assigning priorities for the prospective shape of the DVH curve, as part of treatment plan optimization, of the patient to be treated. The method described herein utilizes historical experience as it evolves to set the location of the constraints using the statistical DVH and the priorities of the constraints based on the weights used in the WES. In particular, statistical data is utilized to provide historical context for prospective treatment values based on the treatment experience of a category of patients with characteristics similar to the patient being treated, wherein selected constraint parameter values and priorities of the patient-treatment plan may be created, incorporated, or modified. In FIG. 21, the selected constraint parameter value(s) 242 attained in part from the weighted experience score (e.g., NCTP WES, GEM WES) and/or associated priority of the selected evaluation metric are shown in a range of confidence-interval bands on the statistical DVH 240. By correlating particular parts of a statistical DVH curve comprised of patient-treatment experience data with an evaluation metric that represents the overall patient treatment-plan quality, a score may be attained that reflects the concerns (e.g., constraint parameters) of treatment personnel and the historical context of the patient treatment-plan. The score may be used to guide changes to the patient treatment-plan and/or shared with other patient-treatment clinics. Furthermore, by utilizing the historical context of the patient treatment-plan experience, the score is capable of continuously evolving as the patient treatment-plan changes. For example, if the DVH curve changes or shifts due to a new planning technique or mobilization method, the related information will automatically be incorporated into the patient treatment-planning approach, without the need to retrain patient treatment personnel.

Alternatively, the GEM may be calculated as a normalized weighed sum of deviation scores. A normalized incomplete gamma function (P) is used to define the sigmoidal curve. P is the cumulative distribution function (c.d.f.) for the gamma probability distribution function (p.d.f.), operating over the same range of input values as DVH metrics (>=0). This selection supports future extension to Bayesian modeling since the gamma p.d.f. is a conjugate prior for a wide range of p.d.f. forms (gamma, poisson, exponential) used in modeling parameters. Details of the gamma p.d.f. and related functions are presented in Appendix A.

An example algorithm using an error function as the sigmoidal curve function for calculating the GEM is described within a correlation data structure shown below:

$$GEM = \frac{{\sum }_{i}^{ } [ {2}^{- ( {Priority}_{i} - 1 )} \cdot P ( {k}_{i} , \frac{Plan {Value}_{i}}{Θ i} ) ]}{{{\sum }_{i}}^{ } {2}^{- ( {Priority}_{i} - 1 )}}$$

If Upper 90% CI>=Constraint Value, the shape parameter k and scale parameter 0 were solved numerically for each structure constraint so that

$$P ( {k}_{i} , \frac{Constraint Value}{Θ i} ) = 0.5 and P ( {k}_{i} , \frac{Upper 90 \% {CI}_{i}}{Θ i} ) = 0.95 .$$

If historical values are well below constraint values (Upper 90% CIᵢ<Constraint Valueᵢ), k and Θ were set to 100 times Constraint Value and 0.01, respectively, to approximated a steep step function.

With this formulation, interpretation of GEM scores is straightforward. A value of 0.5 indicates meeting constraint value thresholds. Higher values, approaching the limit of 1, indicate failure to meet the constraint with the rate of increase tied to overall historical clinical experience with ability to meet the constraint.

As before, priorities used in calculating GEM are assigned according to the concerns of the prescribing physician. The priorities provide relative, qualitative guidance on which constraints to emphasize. In this calculation, a quantifiable definition of priority (Calculated_Priority) was implemented, which can be benchmarked against historical experience. This enables deriving integer prioritizations based on the historical record of clinical priorities, which may be useful in guiding selection of assigned values.

$$Calculated\_Priority = Round ( 1 = {ln}_{2} ( \frac{Count ( plan values \leq constraint values )}{Count ( plan values )} ) )$$

In practice, individual treatment plans may rarely exceed constraint values defined by literature-derived risk factors. In those cases, GEM scores, like NTCP scores, tend to be near zero. An additional alternative is to use an empirical median of the historical population (i.e., GEMₚₒₚ) as the constraint value. Historical distributions determine the steepness of the penalty for exceeding constraint values and allow measured distributions to quantify as-low-as-reasonably-achievable (ALARA) dose limits with respect to historical experience using GEMₚₒₚ.

Again, not all points along the DVH curve are of equal relevance. Toxicities may be more strongly driven by Max[Gy], Mean[Gy] or Dx %[Gy] values dependent on the organ at risk structure. To reflect this, an additional weighting factor (wktᵢ) may be calculated using Kendall's tau (ktᵢ) correlation of Dx %[Gy] values with structure GEM scores. The GEM correlated weighted experience score (WES_GEM) is calculated using the formula

$$WES\_GEM = \frac{{\sum }_{i}^{ } {wb}_{i}^{*} {wpca}_{i}^{*} {wkt}_{i}^{*} {p}_{i}}{{\sum }_{i}^{ } {wb}_{i}^{*} {wpca}_{i}^{*} {wkt}_{i}}$$

Weighting factors (wkt) are set equal to zero for kt<0 so that they only penalize DVH points associated with undesirable outcomes. Kendall tau correlations were also carried out with GEMₚₒₚ or NTCP to create WES_GEMₚₒₚ or WES_NTCP scores.

Use of the alternatively described analytics to construct a common display method characterizing historical experience with DVH constraint metrics was performed and three cohorts were examined: 1) 351 head and neck patients, Rx range 45-76 Gy in 23-38 fractions, 2) 104 prostate patients, Rx range 55-84 Gy in 22-43 fractions, and 3) 77 SBRT Liver patients, Rx range 40-60 Gy in 3 or 5 fractions. Distributions of achieved DVH metrics were compared to threshold values. Clinical prioritization scores were compared to statistically calculated values. Difficulty in meeting each threshold-priority constraint value based on historical experience was quantified with a difficulty ranking score (DRS),

DRS=2^{-(Priority}^{ᵢ}⁻¹⁾·GEM Upper 50% CI

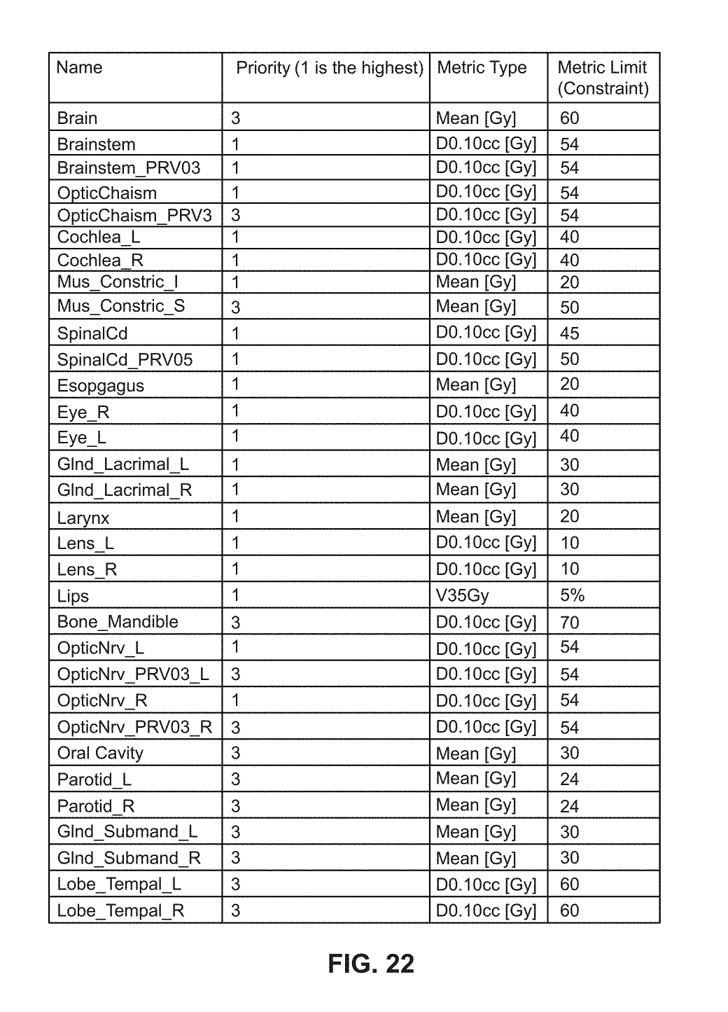

Use of the alternate common display method to facilitate inter-comparison of treatment plan details with reference to historical experience was performed, wherein FIG. 22 depicts example constraints relating to a proposed treatment plan—previously evaluated one by one without benefit of a single numerical scoring system that can rank individual plans in the context of historical experience.

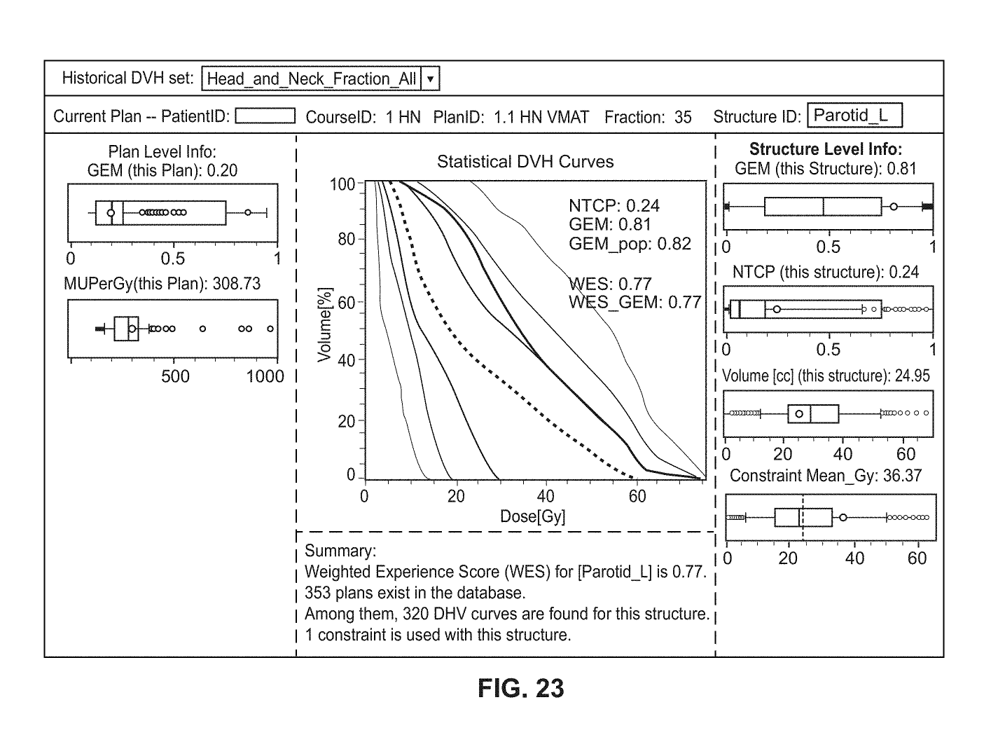

FIG. 23 illustrates a view from a dashboard application that was created to enable use of these concepts from within the treatment planning system. Statistical DVH curves and box and whisker plots are used to display the current plan in the context of distribution of historical values. Overall plan evaluation metrics are displayed in the left panel, and per-structure metrics are displayed in the right panel. In the left panel GEM, calculated over all structures, estimates overall plan quality. Comparison of MU/Gy is a relative indicator of MLC leaf pattern complexity. Distributions of MU/Gy vary substantially with technique (3D, IMRT, VMAT). In the right panel, GEM values for constraints applied to individual structures (left parotid in this example), NTCP, Volume, and individual DVH constraints are displayed.

For the example plan evaluated in FIG. 23, the GEM score was 0.20 using all the constraints in FIG. 22. The GEM score for the left parotid from this plan was 0.81. This indicates that the plan overall compared favorably to constraints and historical experience, but that the dose metric for his structure (i.e., left parotid) was significantly higher than the constraint (GEM=0.81) and historical experience (WES=0.77).

The application uses statistics and weighting factors derived from historical values that are pre-calculated and stored in JSON files. Users select the pre-calculated historical set to use in the comparison and structure DVH to evaluate. Pre-computed statistics rather than run-time query and analysis from M-ROAR was selected for four reasons: 1) minimizing processing time to improve user experience, 2) ability to define standard clinic comparison groups (e.g., patients from 1 year ago vs. 5 years ago), 3) enabling comparison with values derived from other clinics without requiring database access, and 4) support for development of machine learning approaches combining data from multiple clinics.

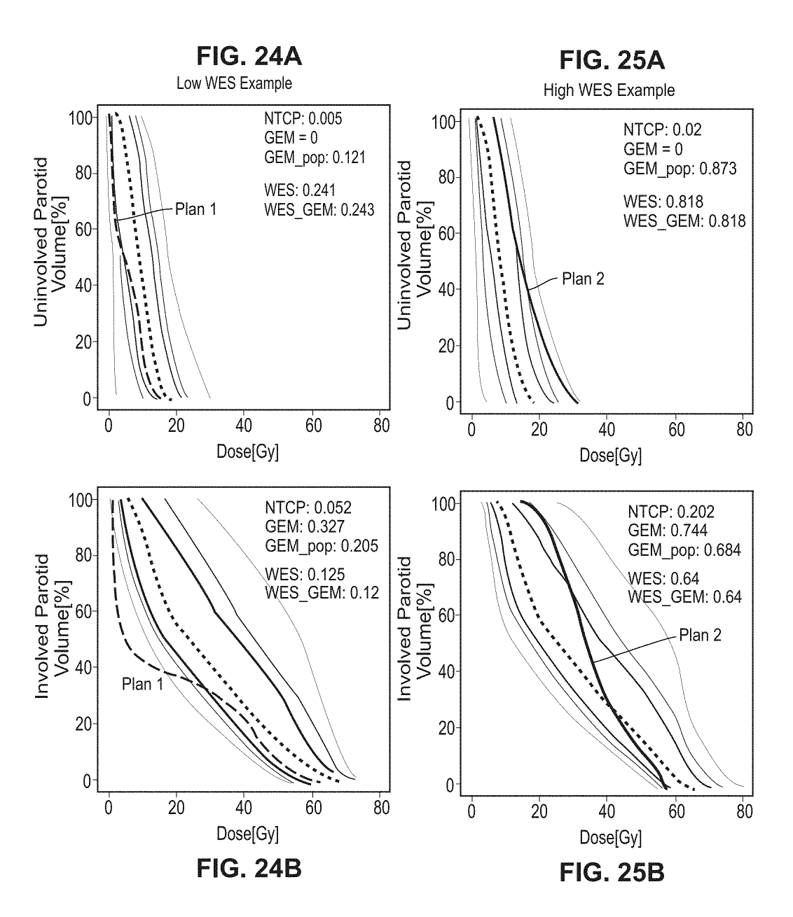

For Head and Neck patients, the distributions of historical values of Max[Gy] for Parotid_L and Parotid_R were found to be bimodal. The midpoint was used to classify parotids as uninvolved (Max[Gy]<=40Gy) or involved (Max[Gy]>40Gy). FIGS. 24A, 24B, 25A, and 25B illustrate use of the statistical DVH and metrics to compare DVH curves for two individual patient plans (e.g., Plan 1, Plan 2) with low (FIG. 24A) and high (FIG. 25A) WES scores for uninvolved parotid (e.g., structure), and low (FIG. 24B) and high (FIG. 25B) WES scores for involved parotid with constraint doses specified for Mean[Gy]. The Plans are shown with respect to the DVH historic context (i.e., a range of historical values). As expected, the dose applied by both Plans to the uninvolved parotid is less than the dose applied to the involved parotid (shown in FIGS. 24B and 25B, respectively), although the dose applied to the uninvolved parotid by Plan 2 is more than that applied by Plan 1; and the relationship with respect to the historical experience can be seen by the comparison of each Plan and the historical DVH values.

Comparison of the two Plans relating to the involved parotid is shown in FIGS. 24B (Plan 1) and 25B (Plan 2). Although the two plans include substantially the same maximum dose, the shape of the DVH curve for the two Plans is quite different. The shape difference may be attributed to the selection and prioritization of the constraints of each plan, which weights different portions of the curve, and is reflected by the difference in the respective WES of each plan. In particular, with a WES of 0.125, Plan 1 is less than the history; while Plan 2, with a WES of 0.64, is significantly more than the history.

The odds of toxicity were low (NTCP 0.02) and compliance with constraint values good (GEM<=0.2) for the uninvolved parotids (see FIGS. 24A and 25A), although Plan 2 with a high WES score (0.818) stood out as having a larger Mean[Gy] dose than was historically normal (GEMₚₒₚ=0.873). WES_GEM and WES_NTCP varied only slightly (<5%) from WES scores indicating that WES scores are viable predictors of ability to meet specific constraint values.

Historic ability to meet the set of constraint values used in treatment plan evaluation was good for all patient groups. Median and 50% CI GEM values were 0.2 (0.13-0.25), 0.09 (0.05-0.12), 0.13 (0.01-0.19), 0.09 (0.04-0.15) for Head and Neck, Prostate, and Liver SBRT with 3 and 5 fractions, respectively.

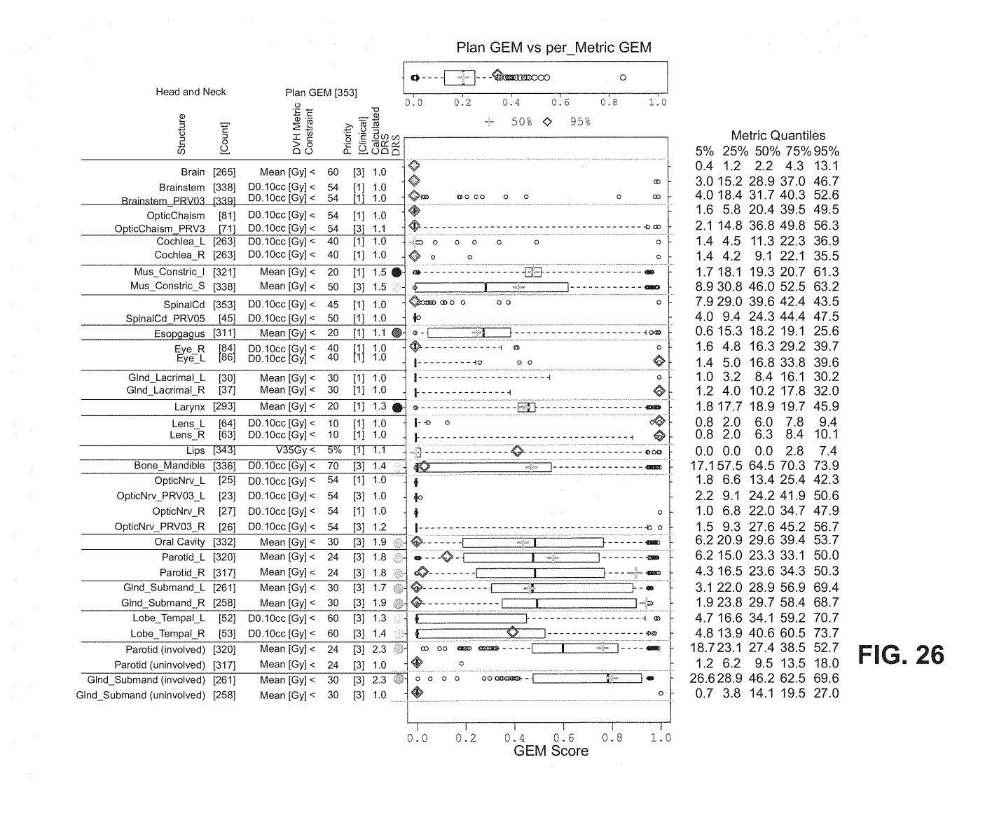

The common range of GEM enabled expanding this plan summary metric to detail historic experience with each threshold-priority constraint in a simple metrics display and use of that display to detail comparisons of individual treatment plans with respect to historic experience. FIG. 26 illustrates this for two head and neck patient plans with GEM scores near to median and upper 90% CI, respectively. In addition to the 32 constraints used in practice, 4 additional constraints for involved and uninvolved parotids and submandibular glands are displayed for reference. The two plans of different difficulty levels, overall plan GEM at median (indicated by “+”) and upper 90% CI (indicated by “0”), are detailed by GEM scores of each threshold-priority constraint (missing data indicates structure not being contoured in that plan). Box-and-whisker plots have their whiskers located at 5% and 95% quantiles of the GEM scores. Their corresponding metric values are tabled in the right columns of Metric Quantiles.

Structures contoured were selected by the physician based on involvement. Superior constrictor muscles (n=338), brain stem (n=338), and brain stem PRV (n=339) were the most frequent, and optic nerve structures (n=25-27) were the least frequent, indicating relative likelihood of involvement. Of the 19 priority 1 structures, only the calculated priority on the inferior constrictor muscle constraint (Mean[Gy]<20) rounded down to a lower integer value of 2, indicating that this constraint is met only about 50% of the time. Possible actions to improve agreement with experience might include modification of the assigned priority to 2 or changing the constraint value to match the upper 75% CI of the achieved metric values (20.7 Gy). Of the 13 priority 3 constraints, calculated values rounded up to integer 1 (n=7) or down to 2 (n=6). GEM scores for these constraints were near to 0 and 0.5, respectively. If it was desirable to further challenge plan evaluations, higher priorities could be assigned.

The numerical values of a difficulty ranking score (DRS) were used to create a gray scale representation of historic difficulty in meeting particular constraints (black=difficult, white=not difficult). The top three difficulty ranking scores were Mean[Gy]<20 for inferior constrictor muscle (0.52), esophagus (0.39) and larynx (0.49). Parotid and submandibular gland DRS was lower (0.19-0.23) due to assigned priority. Historically, constraints were slightly more difficult to meet for right vs. left parotids (0.193 vs. 0.188) and submandibular glands (0.225 vs. 0.223).

Comparing per patient plans to historical experience, the plan with GEM ˜0.5 met all but three constraint values: left and right parotid-Mean[Gy]<24, priority 3 and right submandibular gland-Mean[Gy]<30, priority 3. The amount by which they exceeded constraints was not too far from historical norms (GEM<0.95). The plan with GEM ˜0.95 exceed four priority 1 constraints for eye structures (right eye, right lacrimal gland, left and right lens) by values much larger than historic norms (GEM>0.95) indicating target involvement of these structures on the right side. This was highly unusual compared to historic norms with DRS<0.005.

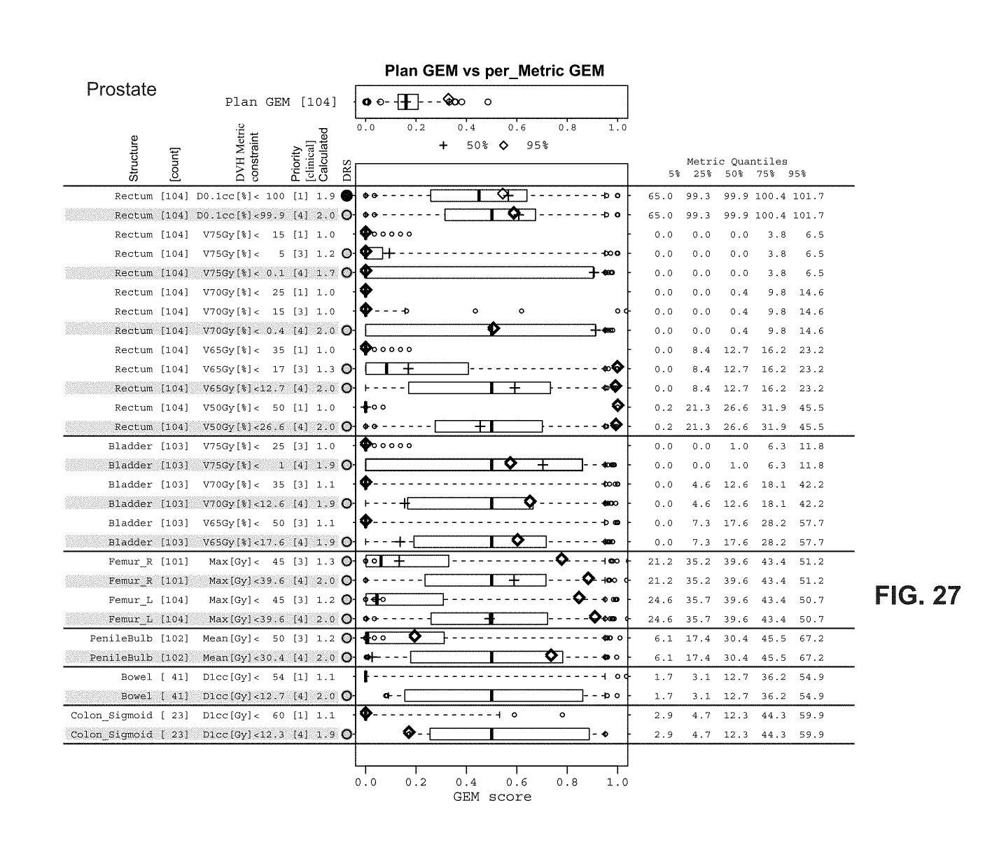

Clinical judgments for selecting between treatment plans and treatment techniques may not be based solely on binary evaluation of ability to meet specified constraints, but also on ability to keep those values as low as possible. The metrics display can be used to reflect that detail by adding low priority constraints with thresholds set to historic medians (i.e., adding ALARA constraints as GEMₚₒₚ). FIG. 27 illustrates this for the cohort of prostate patients and comparing two individual patient plans involving ALARA constraints. ALARA thresholds (constraint values) are set to be the medians of their corresponding metric values, with an assigned priority 4 denoted by a shaded row. For Rectum-V75Gy[%] constraint, which has median 0 Gy, a small number 0.1 is used as the threshold. A priority of 4 was assigned for the ALARA constraints, quantified using GEMₚₒₚ. Since the priority was low, the effect on the plan GEM was small (median 0.14 vs. 0.09).

For priority 1-3 structures only, Rectum-D0.1cc[%]<100 had a high DRS (0.64) with historic values<=101.7 for 95% of patients. It had a calculated priority of 1.9 vs. the assigned value of 1. All other constraints were readily met (GEM<<0.1). For ALARA constraints (priority 4), distribution of GEM values showed variation in upper 50% CI (0.7-0.9) reflecting skewing of the upper end distributions of DVH metrics (toward-away from the median).

Projection of two individual plans onto the box and whisker plots of metrics display provided a visual guide to quantifying the primary issues for each plan. Fifteen of 16 priority 1-3 constraints were met for the first plan with median plan GEM (indicated by “+”). That plan was at the outer range of normal values for Rectum V75Gy[%] and V70Gy[%], with GEM scores near the upper 50% CI of ALARA values. The second plan (indicated by “0”) irradiated a large volume including nodes. It did not meet priority 1 constraints for Rectum-V50Gy[%] or priority 3 constraints for V65Gy[%]. Values for Rectum V70Gy[%] and V75Gy[%] were near to median values for the cohort. (Since Rectum V75Gy[%] has median 0, a small number 0.1 is used as ALARA constraint value.) Priority 3 constraints for both femurs were exceeded with atypically high GEM scores.

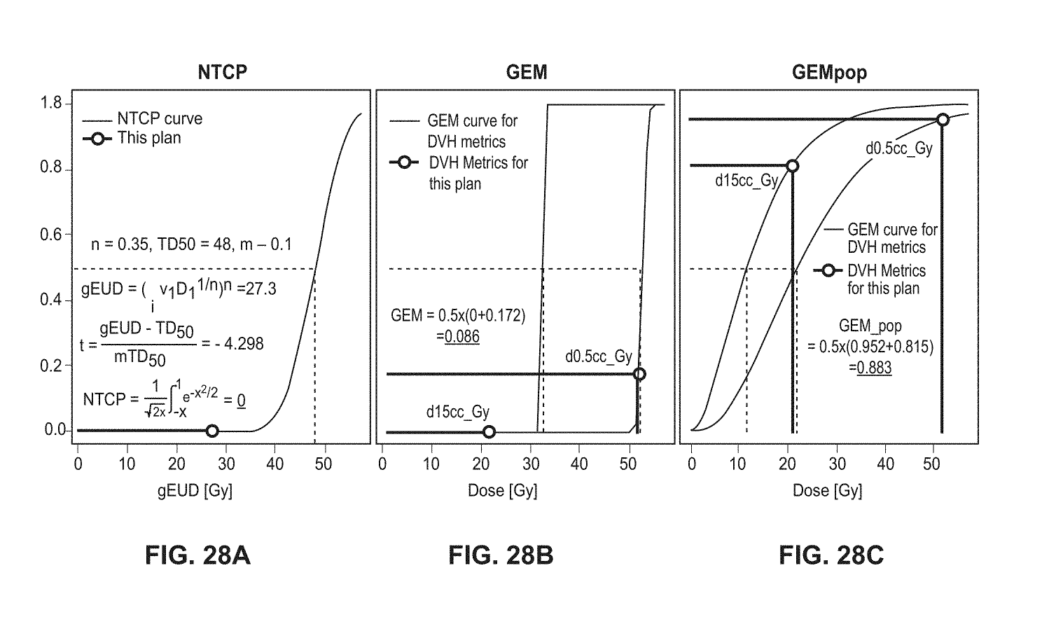

Clinicians select threshold-prioritization values reflecting an implicit intent to minimize normal tissue complication probabilities. GEM and GEMₚₒₚ provided a means of transforming discrete threshold-priority limits into a continuous model reflecting historical experience. As a result, GEM and GEMₚₒₚ scores were shown to be more sensitive to clinically demonstrated actionable decisions on DVH constraints than NTCP. For example, FIGS. 28A, 28B, and 28C illustrate a comparison of NTCP, GEM, and GEMₚₒₚ (α/β=2.5, TD50=48 Gy, n=0.35, m=0.1) calculations on heart dose for a patient for a liver lesion with SBRT in 5 fractions. GEM and GEMₚₒₚ calculations use two priority 1 constraint values D15cc[Gy] and D0.5cc[Gy]. Consistent with more conservative clinical practice, GEM and GEMₚₒₚ rise faster than NTCP.

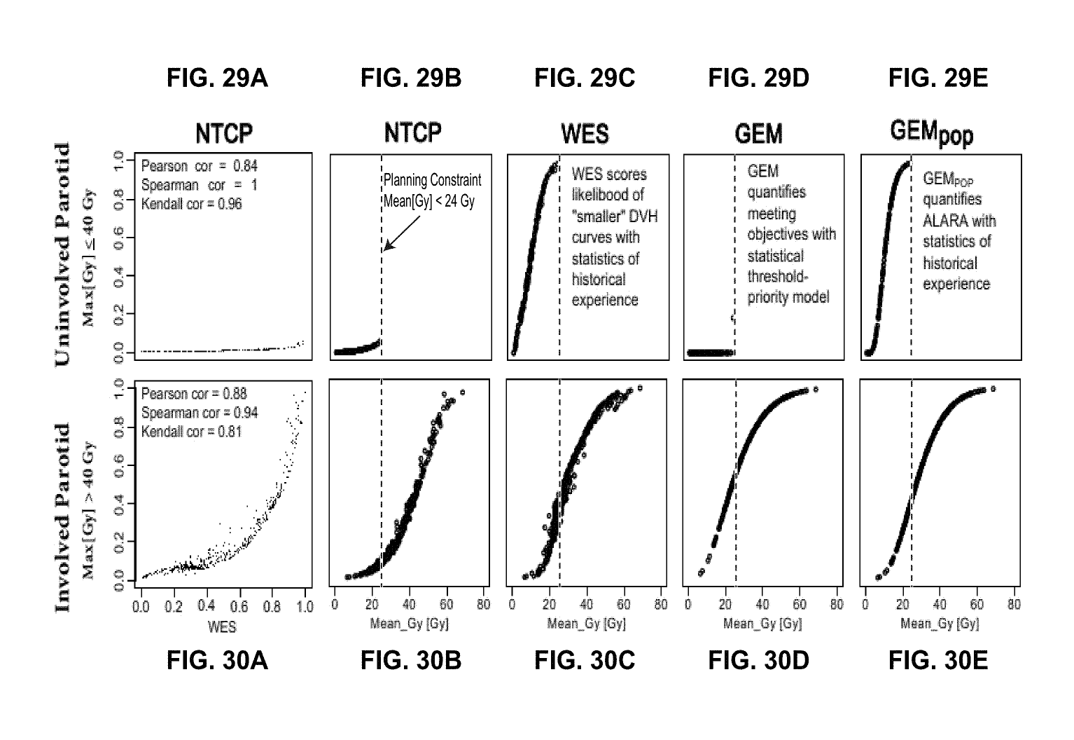

Examining distributions of values, WES, GEM, and GEMₚₒₚ scores correlated strongly with calculated NTCP while also being more sensitive to clinical decisions shaping acceptable characteristics dose distributions. FIGS. 29A-29E and 30A-30E illustrate this comparison for involved (FIGS. 29A-29E) and uninvolved (FIGS. 30A-30E) parotids of head and neck patients, respectively. The increased sensitivity combined with correlation to clinical objectives shows GEM as a better variable for guiding risk reductions than NTCP.

The analytics (metrics, visualization methods and software applications) described herein include a practical demonstration of approaches that could be used to incorporate big data into clinical settings and thereby provide a means to summarize provider-selected objectives into a single score that incorporates historical ability to meet those objectives. Utilizing DVH-based metrics and visualization methods described herein allows for displaying quantitative statistical measures of experience, which provides better information than qualitative recollection, thus providing a treatment planning process for improved patient care.

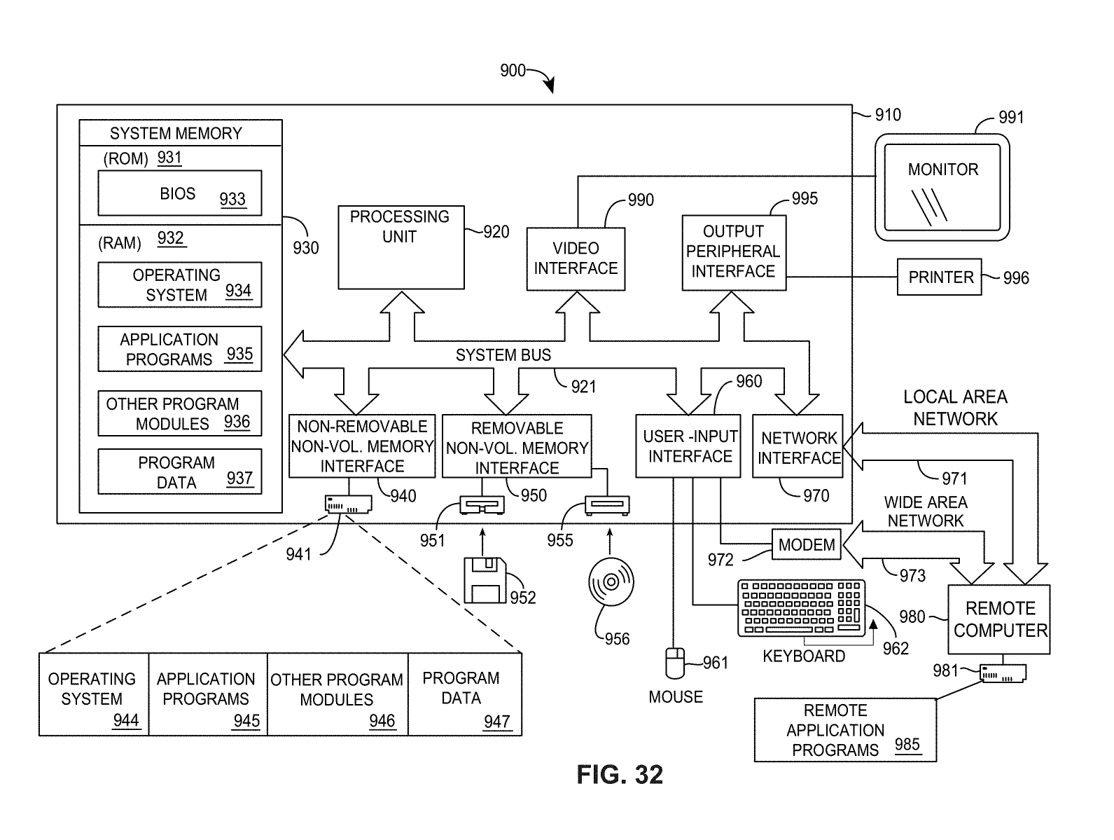

The system, method, and computer-readable medium for treating a patient incorporated by the embodiments described herein may be implemented using an electronic computing system. FIGS. 31 and 32 provide examples embodiments of a structural basis for the network and computational platforms related to such an electronic computing system.

FIG. 31 illustrates an exemplary block diagram of a network 800 and computer hardware that may be utilized in an exemplary system for treating a patient in accordance with the embodiments described herein. The network 800 may be the internet, a virtual private network (VPN), or any other network that allows one or more computers, communication devices, databases, etc., to be communicatively connected to each other. The network 800 may be connected to a computing device, such as a personal computer 812, and a computer terminal 814 via an Ethernet 816 and a router 818, and a landline 820. The Ethernet 816 may be a subnet of a larger Internet Protocol network. Other networked resources, such as projectors or printers (not depicted), may also be supported via the Ethernet 816 or another data network. Additionally, the network 800 may be wirelessly connected to a laptop computer 822 or other mobile computing device such as a personal data assistant 824 or smartphone/tablet via a wireless communication station 826 and a wireless link 828. Similarly, a server 830 may be connected to the network 800 using a communication link 832 and a mainframe 834 may be connected to the network 800 using another communication link 836. The network 800 may be useful for supporting peer-to-peer network traffic. Patient information, e.g., EMR, may also be received from a remotely-accessible, free-standing memory device (not shown) on the network 800. In some embodiments, the patient information may be received by more than one computer. In other embodiments, the patient information may be received from more than one computer and/or remotely-accessible memory device.

Some or all calculations performed in the systems and method described herein, for example, evaluating of a patient-treatment plan in view of an evaluation metric, e.g., NTCP, GEM, GEMₚₒₚ, and/or determining a weighted evaluation score (WES) may be performed by one or more computing devices such as the personal computer 812, laptop computer 822, server 830, and/or mainframe 834, for example. In some embodiments, some or all of the calculations may be performed by more than one computer.

Providing conventional DVH, statistical DVH, GEM, WES, GEMₚₒₚ, box plots, images, and a like attained by the embodiments described herein may also be performed by one or more computing devices as the personal computer 812, laptop computer 822, server 830, and/or mainframe 834, for example. In some embodiments, displaying the calculated results, e.g., GEM, WES, GEMₚₒₚ, box plots; may include sending data over a network such as network 800 to another computing device or display device.

FIG. 32 illustrates an exemplary block diagram of a system 900 on which an exemplary method for facilitating treatment of a patient may operate in accordance with the embodiments described herein. The system 900 of FIG. 32 includes a computing device in the form of a computer 910. Components of the computer 910 may include, and are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 910 typically includes a variety of computer-readable media. Computer-readable media can be any available media that can be accessed by the computer 910 and may include volatile and/or nonvolatile media, as well as removable and/or non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above are also included within the scope of computer-readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules or routines, e.g., analyzing, calculating, predicting, indicating, determining, etc., that are immediately accessible to and/or presently being operated on by a processing unit 920, e.g., modules including the correlation algorithm, the weighting algorithm, scoring algorithm, conventional DVH, statistical DVH, GEM, WES, GEMₚₒₚ, box plots, images, and a like. By way of example, and not limitation, FIG. 32 illustrates operating system 934, application programs 935, other program modules 936, and program data 937.

The computer 910 may also include other removable/non-removable, volatile/nonvolatile computer storage media. By way of example only, FIG. 32 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 31 provide storage of computer-readable instructions, data structures, algorithms, program modules, and other data for the computer 910. In FIG. 32, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through a user interface module including input devices such as a keyboard 962 and cursor control device 961, commonly referred to as a mouse, trackball, touch-screen, or touch pad. A screen 991 or other type of display device is also connected to the system bus 921 via an interface, such as a graphics controller 990. In addition to the screen 991, computers may also include other peripheral output devices such as printer 996, which may be connected through an output peripheral interface 995.

The computer 910 may operate in a networked environment using logical connections to one or more remote computers, such as a remote computer 980. The remote computer 980 may be an integrated monitoring system operatively coupled to an individual via an input/output component or device, e.g., one or more sensors capable of being connected or attached to the patient and sensing biological and/or physiological information. The logical connections depicted in FIG. 32 include a local area network (LAN) 971 and a wide area network (WAN) 973, but may also include other networks. Such networking environments are commonplace in hospitals, offices, enterprise-wide computer networks, intranets, and the internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the internet. The modem 972, which may be internal or external, may be connected to the system bus 921 via the input interface 960, or other appropriate mechanism. In a networked environment, program modules depicted relative to the computer 910, or portions thereof, may be stored in the remote memory storage device 981. By way of example, and not limitation, FIG. 32 illustrates remote application programs 985 as residing on memory device 981.

The communications connections 970, 972 allow the device to communicate with other devices. The communications connections 970, 972 are an example of communication media, which may include both storage media and communication media.

The computing 910 may perform the various processing functions described herein in conjunction with the one or more computers 980 or the various functions may be performed solely by the computing device 910. That is, the processing functions performed by the system may be distributed among a plurality of computes configured in an arrangement known as “cloud computing.” This arrangement may provide several advantages, such as, for example, enabling near real-time uploads and downloads of data as well as periodic uploads and downloads of information. This arrangement may provide for a thin-client embodiment of a mobile computer or tablet and/or stationary computer described in FIG. 32 as a primary backup of some or all of the data gathered by the one or more computers.

The embodiments for the methods of facilitating treatment of a patient in view of past treatment-plan experience of other patients described above may be implemented in part or in their entirety using one or more computer systems such as the computer system 900 illustrated in FIG. 32. The patient information, data structures, and/or algorithms may be received by a computer such as the computer 910, for example. The patient information, data structures, and/or algorithms may be received over a communication medium such as local area network 971 or wide area network 973, via network interface 970 or user-input interface 960, for example. As another example, the patient information, data structures, and/or algorithms may be received from a remote source such as the remote computer 980 where the data is initially stored on memory device such as the memory storage device 981. As another example, the patient information, data structures, and/or algorithms may be received from a removable memory source such as the nonvolatile magnetic disk 952 or the nonvolatile optical disk 956. As another example, the patient information, data structures, and/or algorithms may be received as a result of a human entering data through a user interface, such as a touch-screen, touch pad, and/or keyboard 962.

Some or all analyzing or calculating performed in calculating the correlation between the patient data and the aggregate historical patient data based on a selected evaluation metric described above may be performed by a computer such as the computer 910, and more specifically may be performed by one or more processors, such as the processing unit 920, for example. In some embodiments, some calculations may be performed by a first computer such as the computer 910 while other calculations may be performed by one or more other computers such as the remote computer 980. The analyses and/or calculations may be performed according to instructions that are part of a program such as the application programs 935, the application programs 945 and/or the remote application programs 985, for example.

All calculations described in the embodiments herein, for example, a correlation between the patient data and the aggregate historical patient data based on a selected evaluation metric, may also be performed by a computer such as the computer 910. The constraint parameters, priorities, sigmoidal curve functions, etc. may be made by setting the value of a data field stored in the ROM memory 931 and/or the RAM memory 932, for example. In some embodiments, displaying the dashboards and/or box-plots may include sending data over a network such as the local area network 971 or the wide area network 973 to another computer, such as the remote computer 981. In other embodiments, displaying the dashboards and/or box-plots may include sending data over a video interface such as the video interface 990 to display information relating to the dashboard and/or box-plot on an output device such as the screen 991 or the printer 996, for example.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “predicting,” “proposing,” determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Although the preceding text sets forth a detailed description of numerous different embodiments, it should be understood that the legal scope of the invention is defined by the words of the claims set forth at the end of this patent. The detailed description is to be construed as example only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Moreover, although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims. By way of example, and not limitation, the disclosure herein contemplates at least the following aspects.

Aspect 1: A method of facilitating treatment of a patient, the method executed on a system including one or more operatively coupled processors, a memory component, and a user interface including a display screen, the method comprising receiving, by the one or more processors, patient data associated with a treatment-plan for the patient; providing a patient data structure describing a conventional dose volume histogram associated with the treatment-plan for the patient; rendering, by the one or more processors, an image of the conventional dose volume histogram; receiving aggregate historical patient data associated with an experience of the treatment-plan for at least one historical patient; providing a historical patient data structure describing a statistical patient dose volume histogram associated with the experience of the treatment-plan for the at least one historical patient; rendering, by the one or more processors, an image of the statistical patient dose volume histogram; and simultaneously displaying, by the one or more processors, the rendered images of the conventional dose volume histogram and the statistical dose volume histogram on the display screen for visually evaluating treatment of the patient.

Aspect 2: The method of aspect 1, further comprising: rendering, by the one or more processors, a confidence interval envelop of the statistical patient dose volume histogram; and displaying, by the one or more processors, the rendered confidence interval envelop on the display screen.

Aspect 3: The method of any of aspects 1 or 2, further comprising: providing a correlation data structure describing a correlation between the patient data and the aggregate historical patient data based on a selected evaluation metric; rendering, by the one or more processors, an image of the correlation between the patient data and the aggregate historical patient data based on the selected evaluation metric; and displaying, by the one or more processors, the rendered image of the correlation between the patient data and the aggregate historical patient data.

Aspect 4: The method of aspect 3, wherein the displayed rendered image of the correlation between the patient data and the aggregate historical patient data includes a box-and-whiskers plot diagram.

Aspect 5: The method of aspect 4, further comprising: rendering, by the one or more processors, an image of a treatment-plan dashboard for routine evaluation of the treatment-plan including the rendered images of the conventional dose volume histogram and the statistical dose volume histogram, and the rendered image of the correlation between the patient data and the aggregate historical patient data based on the selected evaluation metric; and displaying, by the one or more processors, the rendered image of the treatment-plan dashboard on the display screen for facilitating treatment of the patient.

Aspect 6: The method of any of aspects 3 or 4, wherein the selected evaluation metric includes any one of the following: normal tissue complication probability (NTCP), tumor control probability (TCP), monitor unit per Gray (MU/Gy), generalized evaluation metric (GEM), empirical median of the historical population (GEMₚₒₚ), dose volume histogram, or radiobiological plan evaluation metrics.

Aspect 7: A method of facilitating treatment-plan of a patient, the method executed on a system including one or more operatively coupled processors, a memory component, and a user interface including a display screen, the method comprising: receiving, at the one or more processors, patient data associated with a treatment-plan for the patient; receiving, at the one or more processors, aggregate historical patient data associated with the treatment-plan for at least one historical patient; providing a correlation data structure including the patient data and the aggregate historical patient data, wherein the correlation data structure describes a correlation between the patient data and the aggregate historical patient data based on a selected evaluation metric; rendering, by the one or more processors, an image of the correlation between the patient data and the aggregate historical patient data based on the selected evaluation metric; and displaying, by the one or more processors, the rendered image of the correlation between the—patient data and the aggregate historical patient data on the display screen for visually evaluating treatment of the patient.

Aspect 8: The method of aspect 7, wherein the patient data includes a conventional dose volume histogram of the patient.

Aspect 9: The method of any of aspects 7 or 8, wherein the aggregate historical patient data includes a statistical dose volume histogram of the at least one historical patient.

Aspect 10: The method of any of aspects 7 through 9, wherein the selected evaluation metric includes any one of the following: normal tissue complication probability (NTCP), tumor control probability (TCP), monitor unit per Gray (MU/Gy), generalized evaluation metric (GEM, dose volume histogram, empirical median of the historical population (GEMₚₒₚ), or radiobiological plan evaluation metrics.

Aspect 11: The method of any of aspects 7 through 10, wherein the correlation of the patient data to the aggregate historical patient data includes weighting the patient data based on the selected evaluation metric.

Aspect 12: The method of any one of aspects 7 through 11, wherein the correlation data structure includes a probability algorithm for determining the probability of a dose distribution point value of the patient data at a volume percentage being less than a dose distribution point value of the aggregate historical patient data at the corresponding volume percentage.

Aspect 13: The method of any of aspects 7 through 12, wherein the correlation data structure includes a correlation algorithm for determining dose distribution point values of the aggregate historical patient data including a higher correlation to the selected evaluation metric, wherein the higher correlation including a Kendall's tau correlation coefficient greater than a predefined upper amount (i.e., 0.4).

Aspect 14: The method of aspect 7, wherein the correlation data structure includes a weighting algorithm for determining weighting values for calculating a weighted experience score, and wherein Kendall's tau correlation coefficient values less than or equal to a weighting threshold (i.e., 0.0) are set to a predefined weighting value (i.e., 0.0).

Aspect 15: The method of any one of aspects 7 through 14, wherein the correlation data structure includes a scoring algorithm for determining a weighted experience score for the patient data with respect to the selected evaluation metric, and wherein the weighted experience score is the sum of the determined probability of a dose distribution point value of the patient data at a volume percentage being less than a dose distribution point value of the aggregate historical patient data at the corresponding value percentage and the determined weighting value at the corresponding volume percentage.

Aspect 16: A method of facilitating treatment-plan of a patient, the method executed on a system including one or more operatively coupled processors, a memory component, and a user interface including a display screen, the method comprising: receiving, at the one or more processors, patient data associated with a treatment-plan for the patient; receiving, at the one or more processors, aggregate historical patient data associated with an experience of the treatment-plan for at least one historical patient; constructing a general evaluation metric; providing a correlation data structure including the patient data and the aggregate historical patient data, wherein the correlation data structure describes a correlation between the patient data and the aggregate historical patient data based on the constructed evaluation metric; rendering, by the one or more processors, an image of the correlation between the patient data and the aggregate historical patient data based on the constructed general evaluation metric; and displaying, by the one or more processors, the rendered image of the correlation between the patient data and the aggregate historical patient data on the display screen for visually evaluating treatment of the patient.

Aspect 17: The method of aspect 16, wherein constructing the general evaluation metric includes: receiving at least one treatment-plan constraint parameter and an associated priority level; providing a sigmoidal curve function, error function, logit function, logistic function, etc., for determining the general evaluation metric; calculating a general evaluation metric value for each patient value of the patient data based on the associated treatment-plan constraint parameter, the associated priority level, and the error function; and calculating a general evaluation metric value for each aggregate historical patient value of the aggregate historical patient data based on the associated treatment-plan constraint parameter, the associated priority level, and the error function.

Aspect 18: The method of any of aspects 16 or 17, wherein the correlation of the patient data to the aggregate historical patient data includes weighting the patient data based on the constructed general evaluation metric.

Aspect 19: The method of any of aspects 16 through 18, wherein the correlation data structure includes a probability algorithm for determining the probability of each patient value of the associated treatment-plan constraint parameter being less than the aggregate historical patient value of the corresponding treatment-plan constraint parameter.

Aspect 20: The method of any of aspects 16 through 19, wherein the correlation data structure includes a correlation algorithm for determining aggregate historical patient values including a higher correlation to the general evaluation metric, wherein the higher correlation including a Kendall's tau correlation coefficient greater than a predefined upper amount (i.e., 0.4).

Aspect 21: The method of aspect 20, wherein the correlation data structure includes a weighting algorithm for determining weighting values for calculating a weighted experience score, wherein Kendall's tau correlation coefficient values less than or equal to a weighting threshold (i.e., 0.0) are set to a predefined weighting value (i.e., 0.0).

Aspect 22: The method of aspect 21, wherein the correlation data structure includes a scoring algorithm for determining a weighted experience score for the patient data with respect to the general evaluation metric, and wherein the weighted experience score is the sum of the determined probability of each patient value of the associated treatment-plan constraint parameter being less than the aggregate historical patient value of the corresponding treatment-plan constraint parameter and the determined weighting value at the corresponding treatment-plan constraint parameter.

Aspect 23: A method of facilitating treatment of a patient, the method executed on a system including one or more operatively coupled processors, a memory component, and a user interface including a display screen, the method comprising: receiving, at the one or more processors, historical patient treatment-plan data associated with an experience of a treatment-plan for a plurality of patients, the historical patient treatment-plan data including a statistical dose volume histogram curve based on statistical information relating to a treatment-plan constraint parameter threshold value and an associated priority value; creating, by the one or more processors, an individual patient treatment-plan for an individual patient based on the historical patient treatment-plan data; treating the individual patient based on the created individual patient treatment-plan; monitoring, by the one or more processors, a response of the individual patient to the individual patient treatment-plan in comparison to the received historical patient treatment-plan data; receiving additional historical patient treatment-plan data; automatically updating, at the one or more processors, the historical patient treatment-plan data based on the received additional historical patient treatment-plan data; adjusting, by the one or more processors, the individual patient treatment-plan based on the updated historical patient treatment-plan data; and treating the individual patient based on the adjusted individual patient treatment-plan.

Aspect 24: The method of aspect 23, wherein the updated historical patient treatment-plan data includes a change to the treatment-plan constraint parameter threshold value or the associated priority value.

Aspect 25: The method of any of aspects 23 or 24, further comprising transmitting, by the one or more processors, the updated historical patient treatment-plan data to a patient treatment clinic.

Aspect 26: The method of any of aspects 23-25, wherein the historical patient treatment-plan data includes intensity modulated radiotherapy (IMRT) and/or volumetric modulated arc radiotherapy (VMAT).

Aspect 27: A system for generating a display to improve decision making of treatment options for a patient with a medical condition, the system comprising: one or more processors; a display device coupled to the one or more processors; a memory coupled to the one or more processors; a patient data structure stored on the memory and describing a conventional dose volume histogram associated with the treatment-plan for the patient; a historical patient data structure stored on the memory and describing a statistical patient dose volume histogram associated with the experience of the treatment-plan for the at least one other patient; a correlation data structure stored on the memory and describing a correlation between the patient data and the aggregate historical patient data based on a selected evaluation metric; and instructions store on the memory that when executed by the one or more processors, cause the system to: receive patient data associated with a treatment-plan for the patient; render an image of the conventional dose volume histogram; receive aggregate historical patient data associated with an experience of the treatment-plan for at least one other patient; render an image of the statistical patient dose volume histogram; display the rendered images of the conventional dose volume histogram and the statistical dose volume histogram on the display screen for visually evaluating treatment of the patient.

Aspect 28: The system of aspect 27, wherein the executed instructions cause the system to: render a confidence interval envelop of the aggregate statistical dose volume histogram; and display the rendered confidence interval envelop on the display screen.

Aspect 29: The system of any one of aspects 27 or 28, wherein the executed instructions cause the system to: render an image of the correlation between the patient data and the aggregate historical patient data based on the selected evaluation metric; and display the rendered image of the correlation between the patient data and the aggregate historical patient data.

Aspect 30: The system of any one of aspects 27-29, wherein the displayed rendered image of the correlation between the patient data and the aggregate historical patient data includes a box-and-whiskers plot diagram.

Aspect 31: The system of any one of aspects 27-30, wherein the executed instructions cause the system to: render an image of a treatment-plan dashboard for routine evaluation of the treatment-plan including the rendered images of the conventional dose volume histogram and the statistical dose volume histogram, and the rendered image of the correlation between the patient data and the aggregate historical patient data based on the selected evaluation metric; and display the rendered image of the treatment-plan dashboard on the display screen for facilitating treatment of the patient.

Aspect 32: The system of any one of aspects 27-31, wherein the selected evaluation metric includes any one of the following: normal tissue complication probability (NTCP), tumor control probability (TCP), monitor unit per Gray (MU/Gy), generalized evaluation metric (GEM), empirical median of the historical population (GEMₚₒₚ), dose volume histogram, or radiobiological plan evaluation metrics.

### APPENDIX A—RELATED FUNCTIONS

Incomplete Gamma Function

$$\begin{matrix}γ ( k , \frac{x}{θ} ) = {\int }_{0}^{\frac{x}{θ}} {t}^{k - 1} {e}^{- t} dt & ( A .1 ) \\ Mean = k θ & ( A .2 ) \\ Var = k {θ}^{2} & ( A .3 )\end{matrix}$$

Gamma Function

Γ(k)=∫₀^{∞}t^{k-1}e^{-t}dt (A.4)

Normalized Incomplete Gamma Function

$$P ( k , \frac{x}{θ} ) = \frac{γ ( k , \frac{x}{θ} )}{Γ ( k )} \qquad ( A .5 )$$

Gamma Distribution p.d.f.

$$p ( x \vert k , θ ) = \frac{1}{Γ ( k ) {θ}^{k}} {x}^{k - 1} {e}^{- \frac{x}{θ}} \qquad ( A .6 )$$

Gamma Distribution c.d.f.

$$c ( x \vert k , θ ) = P ( k , \frac{x}{θ} ) \qquad ( A .7 )$$

Normal Distribution p.d.f.

$$p ( x \vert k , σ ) = \frac{1}{\sqrt{2 {σ}^{2} π}} {e}^{\frac{{( x - μ )}^{2}}{{σ}^{3}}} \qquad ( A .8 )$$

Normal Distribution c.d.f.

$$c ( x \vert k , σ ) = \frac{1}{2} ( 1 + erf ( \frac{x - μ}{σ \sqrt{2}} ) ) \qquad ( A .9 )$$

Relationship of incomplete gamma function to error function

$$\frac{Γ ( \frac{1}{2} ) P ( \frac{1}{2} , x )}{\sqrt{π}} = erf ( x ) \qquad ( A .10 )$$

Sigmoidal curve using Normal C.D.F. The normal p.d.f. is frequently used for values that can range over positive and negative values. In that case the sigmoidal function used in the GEM calculation is the normal c.d.f.

$$GEM = \frac{\begin{matrix}{\sum }_{i}^{ } [ {2}^{- ( {Priority}_{i} - 1 )} \cdot \\ 1 \text{/} 2 ( 1 + erf ( \frac{{Plan Value}_{i} - {ConstraintValue}_{i}}{{q}_{i} \cdot {ConstraintValue}_{i}} ) ) ]\end{matrix}}{{\sum }_{i}^{ } {2}^{- ( {Priority}_{i} - 1 )}} \qquad ( A .11 )$$

If Upper 90% CI≧Constraint Value, q is selected for

$$1 \text{/} 2 ( 1 + erf ( \frac{Upper 90 \% {CI}_{i} - Constraint {Value}_{i}}{{q}_{i} \cdot Constraint {Value}_{i}} ) ) = 0.95 \qquad ( A .12 )$$

If historical values are well below constraint values (Upper 90% CIᵢ<Constraint Valueᵢ), q is set equal to 0.05 approximating a steep step function.

What is claimed:

1. A method of generating a display to improve decision making for treatment options of a patient with a medical condition, the method executed on a system including one or more operatively coupled processors, a memory component, and a user interface including a display screen, the method comprising:
receiving, at the one or more processors, patient data associated with a treatment-plan for the patient;
providing a patient data structure describing a conventional dose volume histogram associated with the treatment-plan for the patient;
rendering, by the one or more processors, an image of the conventional dose volume histogram;
receiving, at the one or more processors, aggregate historical patient data associated with an experience of the treatment-plan for at least one other patient;
providing a historical patient data structure describing a statistical patient dose volume histogram associated with the experience of the treatment-plan for the at least one other patient;
rendering, by the one or more processors, an image of the statistical patient dose volume histogram;
displaying, by the one or more processors, the rendered images of the conventional dose volume histogram and the statistical dose volume histogram on the display screen for visually evaluating treatment of the patient.

2. The method of claim 1, further comprising:
rendering, by the one or more processors, a confidence interval envelop of the aggregate statistical dose volume histogram; and
displaying, by the one or more processors, the rendered confidence interval envelop on the display screen.

3. The method claim 1, further comprising:
providing a correlation data structure describing a correlation between the patient data and the aggregate historical patient data based on a selected evaluation metric;
rendering, by the one or more processors, an image of the correlation between the patient data and the aggregate historical patient data based on the selected evaluation metric; and
displaying, by the one or more processors, the rendered image of the correlation between the patient data and the aggregate historical patient data.

4. The method of claim 3, wherein the displayed rendered image of the correlation between the patient data and the aggregate historical patient data includes a box-and-whiskers plot diagram.

5. The method of claim 4, further comprising:
rendering, by the one or more processors, an image of a treatment-plan dashboard for routine evaluation of the treatment-plan including the rendered images of the conventional dose volume histogram and the statistical dose volume histogram, and the rendered image of the correlation between the patient data and the aggregate historical patient data based on the selected evaluation metric; and
displaying, by the one or more processors, the rendered image of the treatment-plan dashboard on the display screen for facilitating treatment of the patient.

6. The method of claim 3, wherein the selected evaluation metric includes any one of the following: normal tissue complication probability (NTCP), tumor control probability (TCP), monitor unit per Gray (MU/Gy), generalized evaluation metric (GEM), empirical median of the historical population (GEMₚₒₚ), dose volume histogram, or radiobiological plan evaluation metrics.

7. A method of generating a display to improve decision making for treatment options of a patient with a medical condition, the method executed on a system including one or more operatively coupled processors, a memory component, and a user interface including a display screen, the method comprising:
receiving, at the one or more processors, patient data associated with a treatment-plan for the patient;
receiving, at the one or more processors, aggregate historical patient data associated with an experience of the treatment-plan for at least one other patient;
providing a correlation data structure including the patient data and the aggregate historical patient data, wherein the correlation data structure describes a correlation between the patient data and the aggregate historical patient data based on a selected evaluation metric;
rendering, by the one or more processors, an image of the correlation between the patient data and the aggregate historical patient data based on the selected evaluation metric; and
displaying, by the one or more processors, the rendered image of the correlation between the patient data and the aggregate historical patient data on the display screen for visually evaluating treatment of the patient.

8. The method of claim 7, wherein the patient data includes a conventional dose volume histogram of the patient.

9. The method of claim 7, wherein the aggregate historical patient data includes a statistical dose volume histogram of the at least one other patient.

10. The method of claim 7, wherein the selected evaluation metric includes any one of the following: normal tissue complication probability (NTCP), tumor control probability (TCP), monitor unit per Gray (MU/Gy), generalized evaluation metric (GEM), empirical median of the historical population (GEMₚₒₚ), dose volume histogram, or radiobiological plan evaluation metrics.

11. The method of claim 7, wherein the correlation of the patient data to the aggregate historical patient data includes weighting the patient data based on the selected evaluation metric.

12. The method of claim 7, wherein the correlation data structure includes a probability algorithm for determining the probability of a dose distribution point value of the patient data at a volume percentage being less than a dose distribution point value of the aggregate historical patient data at the corresponding volume percentage.

13. The method of claim 7, wherein the correlation data structure includes a correlation algorithm for determining dose distribution point values of the aggregate historical patient data including a higher correlation to the selected evaluation metric, wherein the higher correlation including a Kendall's tau correlation coefficient greater than a predefined upper amount.

14. The method of claim 13, wherein the correlation data structure includes a weighting algorithm for determining weighting values for calculating a weighted experience score, wherein Kendall's tau correlation coefficient values less than or equal to a weighting threshold are set to a predefined weighting value.

15. The method of claim 7, wherein the correlation data structure includes a scoring algorithm for determining a weighted experience score for the patient data with respect to the selected evaluation metric, and wherein the weighted experience score is the sum of the determined probability of a dose distribution point value of the patient data at a volume percentage being less than a dose distribution point value of the aggregate historical patient data at the corresponding value percentage and the determined weighting value at the corresponding volume percentage.

16. A system for generating a display to improve decision making of treatment options for a patient with a medical condition, the system comprising:
one or more processors;
a display device coupled to the one or more processors;
a memory coupled to the one or more processors;
a patient data structure stored on the memory and describing a conventional dose volume histogram associated with the treatment-plan for the patient;
a historical patient data structure stored on the memory and describing a statistical patient dose volume histogram associated with the experience of the treatment-plan for the at least one other patient;
a correlation data structure stored on the memory and describing a correlation between the patient data and the aggregate historical patient data based on a selected evaluation metric; and
instructions store on the memory and when executed by the one or more processors, cause the system to:
receive patient data associated with a treatment-plan for the patient;
render an image of the conventional dose volume histogram;
receive aggregate historical patient data associated with an experience of the treatment-plan for at least one other patient;
render an image of the statistical patient dose volume histogram;
display the rendered images of the conventional dose volume histogram and the statistical dose volume histogram on the display screen for visually evaluating treatment of the patient.

17. The system of claim 16, wherein the executed instructions cause the system to:
render a confidence interval envelop of the aggregate statistical dose volume histogram; and
display the rendered confidence interval envelop on the display screen.

18. The system of claim 16, wherein the executed instructions cause the system to:
render an image of the correlation between the patient data and the aggregate historical patient data based on the selected evaluation metric; and
display the rendered image of the correlation between the patient data and the aggregate historical patient data.

19. The system of claim 18, wherein the displayed rendered image of the correlation between the patient data and the aggregate historical patient data includes a box-and-whiskers plot diagram.

20. The system of claim 16, wherein the executed instructions cause the system to:
render an image of a treatment-plan dashboard for routine evaluation of the treatment-plan including the rendered images of the conventional dose volume histogram and the statistical dose volume histogram, and the rendered image of the correlation between the patient data and the aggregate historical patient data based on the selected evaluation metric; and
display the rendered image of the treatment-plan dashboard on the display screen for facilitating treatment of the patient.

21. The system of claim 16, wherein the selected evaluation metric includes any one of the following: normal tissue complication probability (NTCP), tumor control probability (TCP), monitor unit per Gray (MU/Gy), generalized evaluation metric (GEM), empirical median of the historical population (GEMₚₒₚ), dose volume histogram, or radiobiological plan evaluation metrics.
